(19) United States
(12) Patent Application Publication
(10) Pub. No.: US 2026/0111865 A1
(43) Pub. Date: Apr. 23, 2026

(54) SELF-SERVICE TERMINAL

(71) Applicant: Diebold Nixdorf Systems GmbH, Paderborn (DE)

(72) Inventors: Nicolas Boesendorfer, Paderborn (DE); Zdravko Nikolic, Paderborn (DE); Anja Palitza, Paderborn (DE); Uwe Kirschke, Paderborn (DE)

(21) Appl. No.: 19/146,741

(22) PCT Filed: Jan. 4, 2024
(86) PCT No.: PCT/EP2024/050152

§ 371 Date: Sep. 4, 2025

(30) Foreign Application Priority Data
Jan. 11, 2023 (EP) 23151173.4

(51) Int. Cl. G06Q 20/18; G06F 1/16

(52) U.S. Cl. CPC G06Q 20/18; G06F 1/1605

(57) ABSTRACT

A self-service terminal is disclosed, comprising: a housing having a first and second linear insertion guide sections which run parallel to one another and define a common linear insertion direction and are arranged at a distance from one another across the linear insertion direction; a display and/or control apparatus mounted on the housing and oriented towards a user of the self-service terminal; a processor designed to provide a graphical display and user interface on the display apparatus to assist the user in a self-service process on the self-service terminal; a mounting element detachably mounted on a base and which has a first and a second correspondence linear insertion guide section, such that the housing and the mounting element mounted on the base can be assembled along the linear insertion direction by linear insertion to detachably fix the housing on the base by the mounting element.

### BACKGROUND

### 1. Field

Various exemplary embodiments relate to a self-service terminal.

### 2. Description of Related Prior Art

At a self-service terminal, such as a self-service checkout, a user can use various services (e.g. paying for a purchase) without interacting with an additional person. For operators of such a self-service terminal (e.g. a shop operator), it can be advantageous if the self-service terminal is, for example, cost-effective and flexible.

### SUMMARY

Various embodiments relate to such a cost-effective and flexible self-service terminal. Thus, according to various embodiments, a self-service terminal is provided which can be flexibly connected to (e.g. desired and/or required) peripheral devices. This is made possible, for example, by the modular expansion of the self-service terminal housing (e.g. on-site in the application). This allows a store operator, for example, to set up a specific layout of the self-service terminal (e.g. certain peripheral devices and/or their arrangement) depending on the wishes and/or requirements on site. This allows, on the one hand, that the housing can be expanded with one or more peripheral devices (e.g. a (receipt) printer, a card reader, a verification device, a handheld scanner, etc.), and, on the other hand, that the structure of the self-service terminal can be changed on site at a later date (e.g. by replacing a peripheral device, adding a peripheral device, omitting a peripheral device, swapping peripheral devices, etc.). This also facilitates the replacement of peripheral devices of the self-service terminal (e.g. in case of a defective peripheral device). Consequently, the costs of operating the self-service terminal can be reduced while at the same time providing increased flexibility in terms of design (e.g., peripheral devices) and adaptation to new circumstances (e.g., additionally required peripheral devices). In the event of maintenance and/or repair of the self-service terminal, it may be necessary to open a housing of the self-service terminal in order to gain access to individual components such as connection points, controllers, fastenings, etc. According to various aspects, the cost of operating the self-service terminal can be reduced by allowing the self-service terminal to be opened in a simple manner. This is made possible by swiveling a display and/or control device to the side and then folding open a cover on the front of the housing. This also enables, for example, a compact design of the self-service terminal. According to various embodiments, connection locations can be arranged at the rear inside the housing and connecting cables can be held by means of a cover flap in a section adjacent to the rear, whereby they do not hinder, for example, access to the remaining section of the housing interior and thus facilitate the maintenance and/or repair process. According to various aspects, the cost of operating the self-service terminal can be reduced by allowing the self-service terminal to be opened in a simple manner. This is made possible, for example, by linearly inserting sections of the housing into a fastening element and attaching them to a base by means of the fastening element. Furthermore, connecting cables, for example, can be easily led into or out of the housing (e.g. without the risk of them becoming trapped).

### BRIEF DESCRIPTION OF THE DRAWINGS

In the drawings,

FIGS. 1A to 1C each show a self-service terminal according to various embodiments;

FIGS. 1D and 1E show exemplary base units on which the self-service terminal can be arranged according to various embodiments;

FIG. 1F shows a wall-mounted self-service terminal according to various embodiments;

FIGS. 2A to 2E show aspects relating to linear insertion guide sections of a housing of the self-service terminal and to a fastening element by means of which the housing can be detachably fastened to a base according to various embodiments;

FIGS. 3A to 3L show aspects relating to a connecting element by means of which one or more peripheral devices can be fastened to a housing of the self-service terminal according to various embodiments;

FIGS. 4A to 4E show aspects relating to various pivoting devices of the self-service terminal according to various embodiments; and

FIGS. 5A to 5D show aspects relating to a configuration of a rear side of the self-service terminal according to various embodiments.

### DETAILED DESCRIPTION

In the following detailed description, reference is made to the accompanying drawings, which form a part hereof, and in which by way of illustration specific embodiments are shown in which the invention may be practiced. In this regard, directional terminology such as “top”, “bottom”, “front”, “back” is used, and for sides of a self-service terminal, terms such as “upper side”, “lower side”, “front side”, “rear side”, “lateral side” are used. This directional terminology is described from the perspective of a user of the self-service terminal and is not to be understood as restrictive in any way.

The term “processor” can be understood as any type of entity that allows the processing of data or signals. For example, the data or signals may be treated according to at least one (i.e., one or more than one) specific function performed by the processor. A processor may include or be formed from an analog circuit, a digital circuit, a mixed-signal circuit, a logic circuit, a microprocessor, a central processing unit (CPU), a graphics processing unit (GPU), a digital signal processor (DSP), a programmable gate array (FPGA), an integrated circuit, or any combination thereof. Any other way of implementing the respective functions, which are described in more detail below, can also be understood as a processor or logic circuit. It is understood that one or more of the method steps described in detail herein may be performed (e.g., realized) by a processor, by one or more specific functions performed by the processor. The processor may therefore be configured to perform one of the methods described herein or its components for information processing.

For operators of a self-service terminal, such as a self-service checkout, it can be advantageous if the self-service terminal is cost-effective and flexible, both initially and during subsequent operation. For example, the requirements for the self-service terminal may change over time, so that a certain peripheral device may not be needed and/or desired until a later date. Various embodiments relate to a self-service terminal that is modularly expandable, allowing the self-service terminal to be flexibly connected to peripheral devices, which also reduces costs. For example, costs can be reduced when assembling the self-service terminal. Various embodiments relate to a self-service terminal that can be assembled in a simple manner. For example, costs can be reduced when operating the self-service terminal. Various embodiments relate to a self-service terminal which can be easily maintained and/or repaired. For example, the self-service terminal can be easily opened to gain access to the interior of the housing. This can also make it easier, for example, to connect the housing to the peripherals.

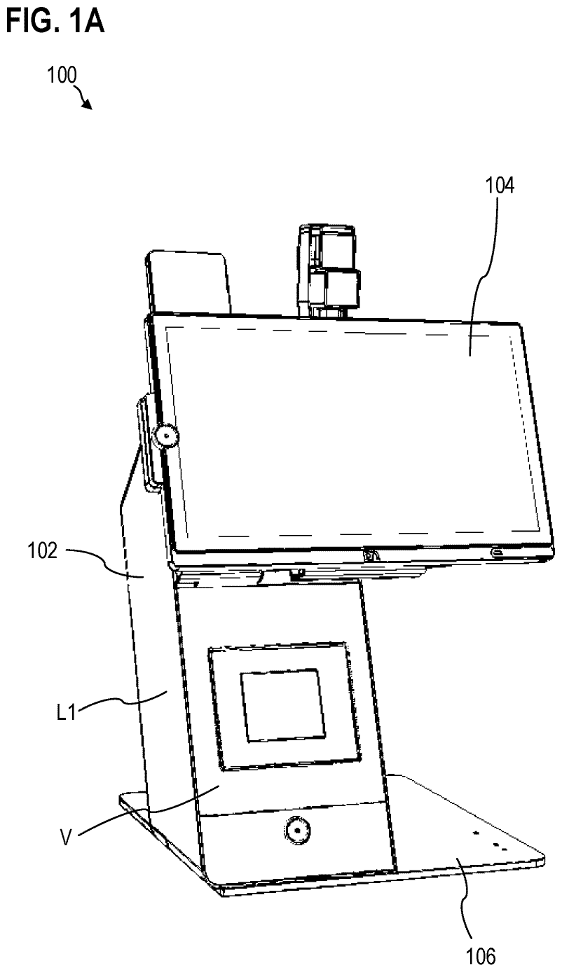

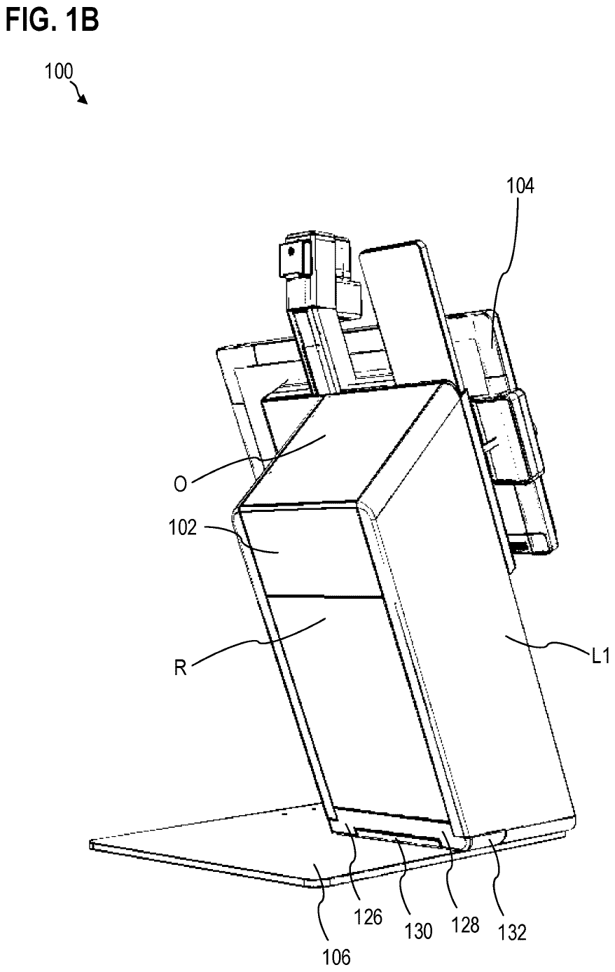

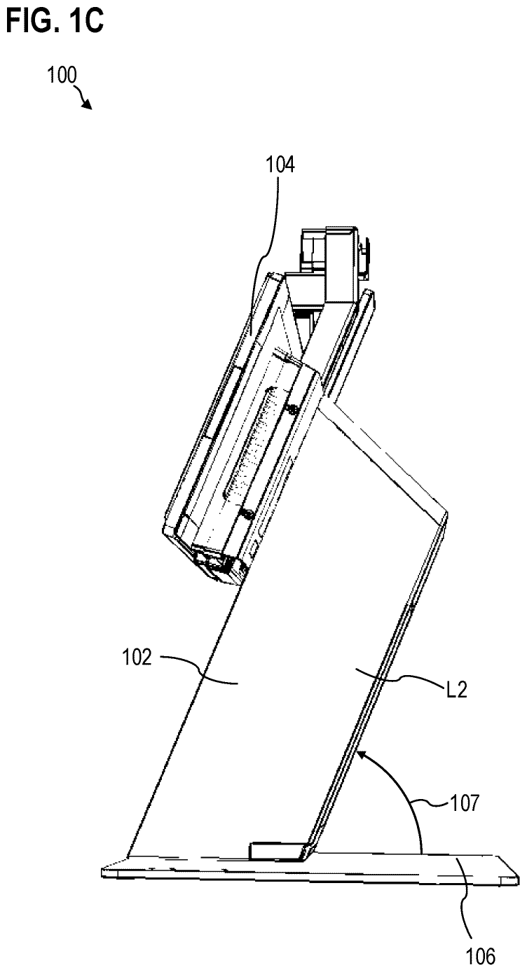

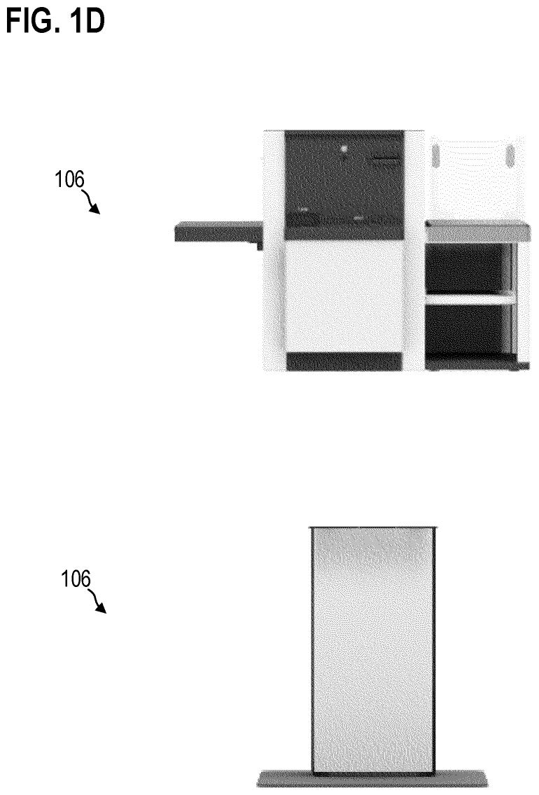

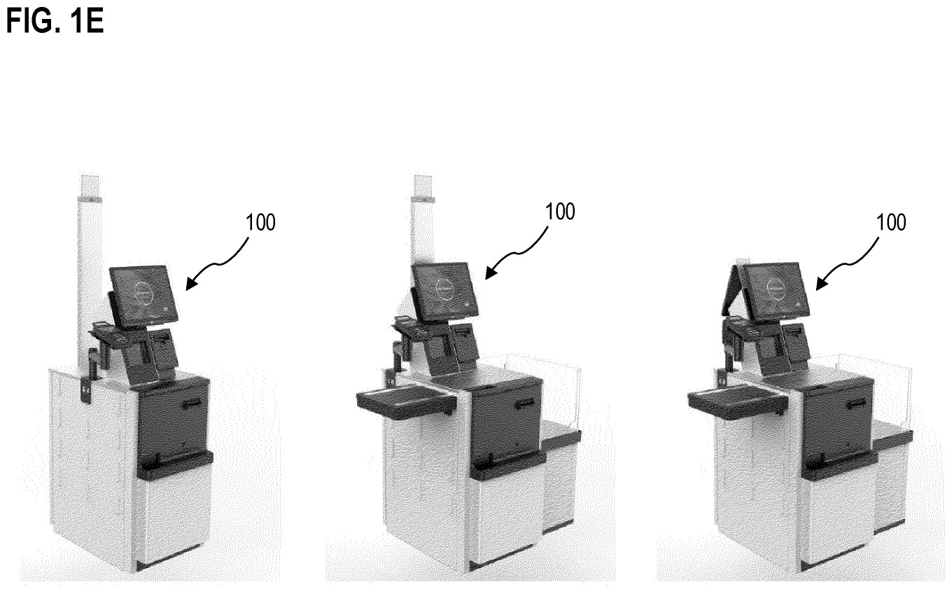

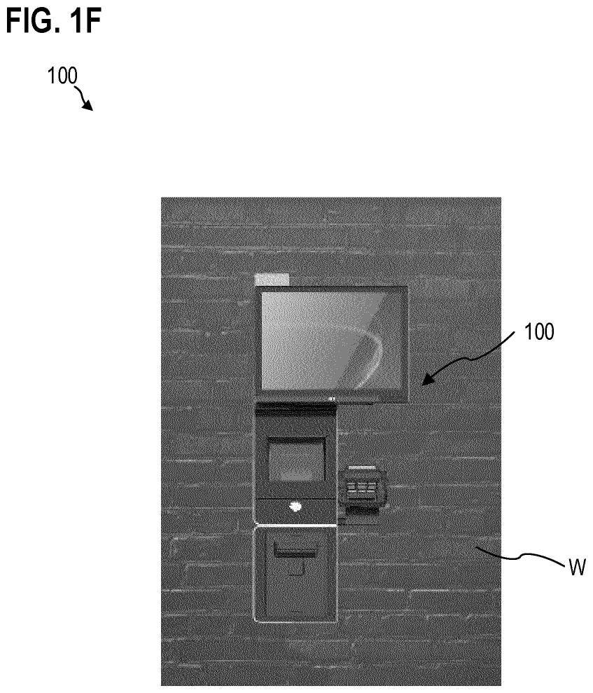

FIG. 1A to FIG. 1C show various perspective views of a self-service terminal 100 according to various embodiments. The self-service terminal 100 may be, for example, a self-service checkout or a self-service kiosk.

The self-service terminal 100 may have a housing 102. The housing 102 of the self-service terminal 100 may have a front side, V, facing a user of the self-service terminal (e.g., a customer of the self-service checkout or self-service kiosk). The housing 102 may have a rear side, R, opposite the front side, V. The housing 102 may have a first lateral side, L1, (also referred to as a left side in some aspects) lateral to the front side, V. The housing 102 may have a second lateral side, L2, (also referred to as a right side in some aspects) opposite the first lateral side, L1, lateral to the front side, V. The housing 102 may have an upper side, O, and a lower side, U, opposite the upper side. The housing 102 may define a vertical axis passing through the upper and lower side.

The housing 102 may consist of one component or of multiple components.

The self-service terminal 100 may have a display and/or control device 104. The display and/or control device 104 can be fastened to the housing 102. The display and/or control device 104 can be oriented towards the user of the self-service terminal 100. The display and/or control device 104 may, for example, have a screen. The display and/or control device 104 may, for example, have a touchscreen which (as a user interface) enables operation of the self-service terminal 100.

The self-service terminal 100 may further include one or more processors. The one or more processors may be any type of logic-implementing entity as described herein. The one or more processors may be configured to provide a graphical display and/or user interface on the display and/or user interface 104. The display and/or user interface can support the user in a self-service process at the self-service terminal 100. In some aspects, software (e.g., a point-of-sale program) for operating the self-service terminal 100 may be implemented by the one or more processors. In other aspects, the software may be implemented on a (e.g., terminal) server (connected to the self-service terminal 100 via a wired and/or wireless network) (e.g. by cloud-computing) and the one or more processors may provide a corresponding display and/or user interface on the display and/or control device 104 (e.g., according to instructions received from the server) (e.g., the one or more processors may be part of a thin client).

The self-service terminal 100 may include a storage device. The one or more processors may be configured to use the storage device in processing data. The storage device may comprise at least one memory. A memory may, for example, be a volatile memory, for example a DRAM (dynamic random access memory), or a non-volatile memory, for example a PROM (programmable read-only memory), an EPROM (erasable PROM), an EEPROM (electrically erasable PROM) or a flash memory, such as a floating gate memory device, a charge trapping memory device, an MRAM (magnetoresistive random access memory) or a PCRAM (phase change random access memory).

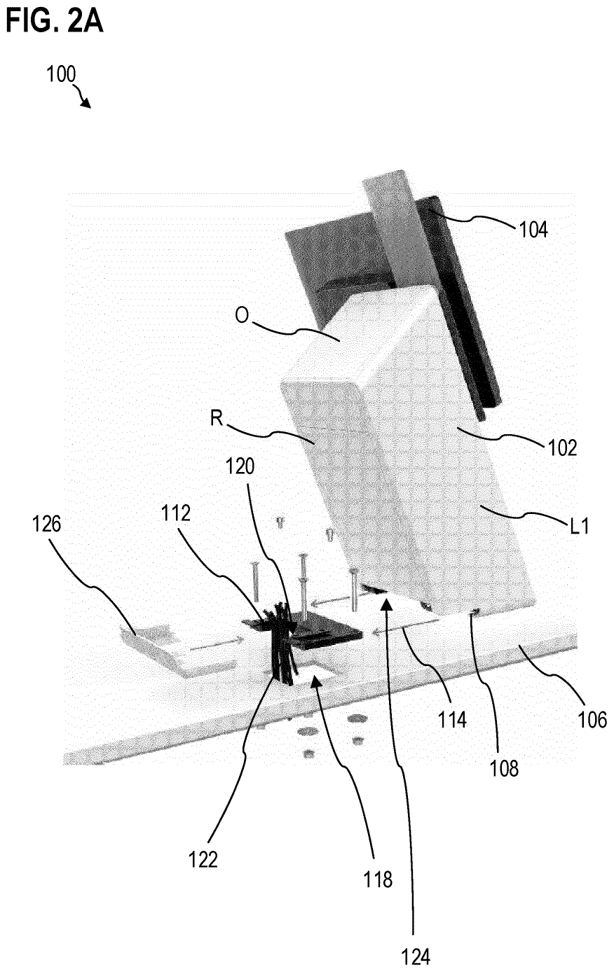

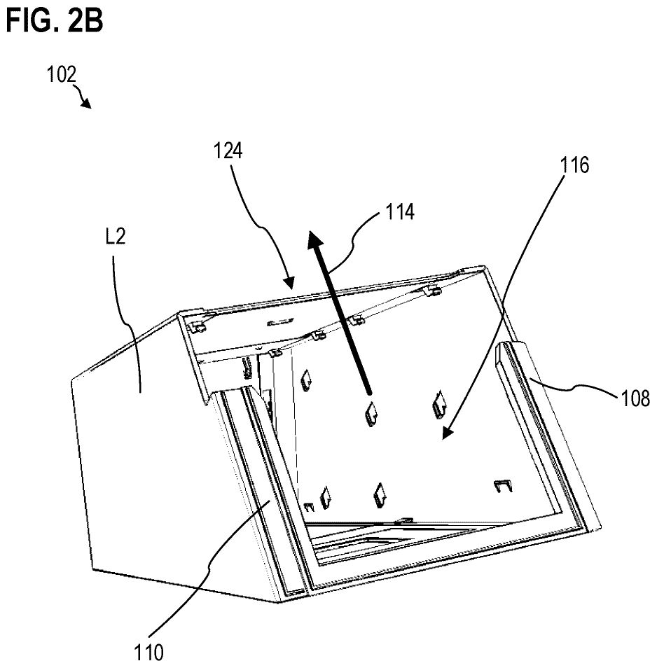

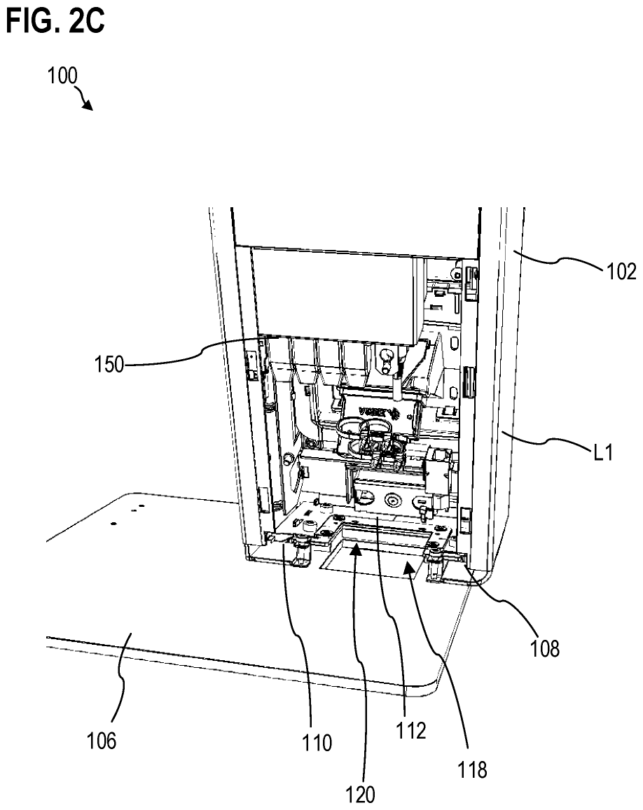

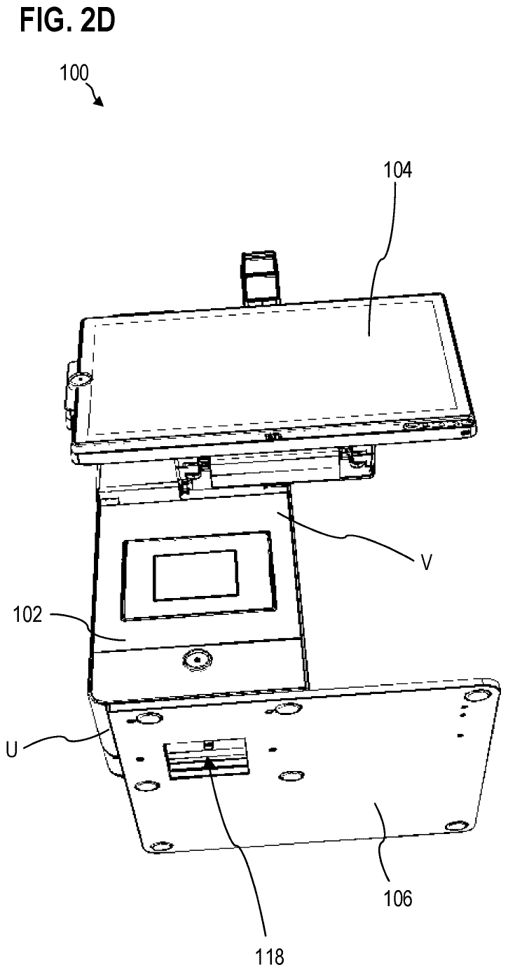

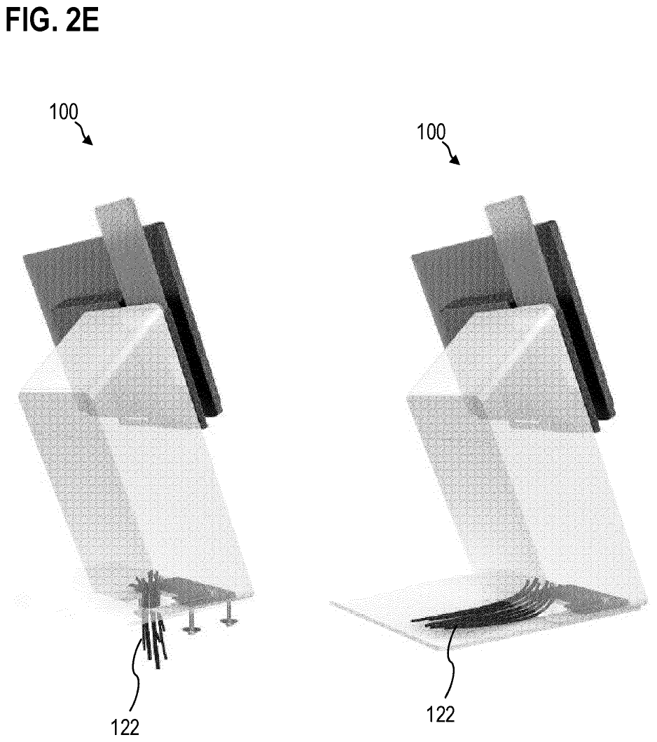

The self-service terminal 100 may be configured to be removably attachable to a base 106. An exemplary embodiment of the self-service terminal 100 according to which the self-service terminal 100 can be detachably fastened to the base 106 is described, for example, with reference to FIG. 2A to FIG. 2E. The base 106 may be a base plate, as shown, for example, in FIG. 1A to FIG. 1C. The base 106 may include or be a base unit with a cash module, for example, as shown above in FIG. 1D. The base 106 may include or be a pedestal as the base unit, for example, as shown below in FIG. 1D. According to various embodiments, the self-service terminal 100 may be detachably fastened to a base plate as base 106, and the base plate may be detachably fastened to a base unit (e.g., a pedestal or a base unit with a cash module). FIG. 1E shows the self-service terminal 100 (with various optional peripherals) mounted on various base units. Also, the self-service terminal 100 mounted on the base 106 can be used on an object (e.g., a table, a shelf, etc.) without being fastened thereto. Alternatively to the base units, the self-service terminal 100, as shown in FIG. 1F, may be configured to be detachably fastened to a wall, W.

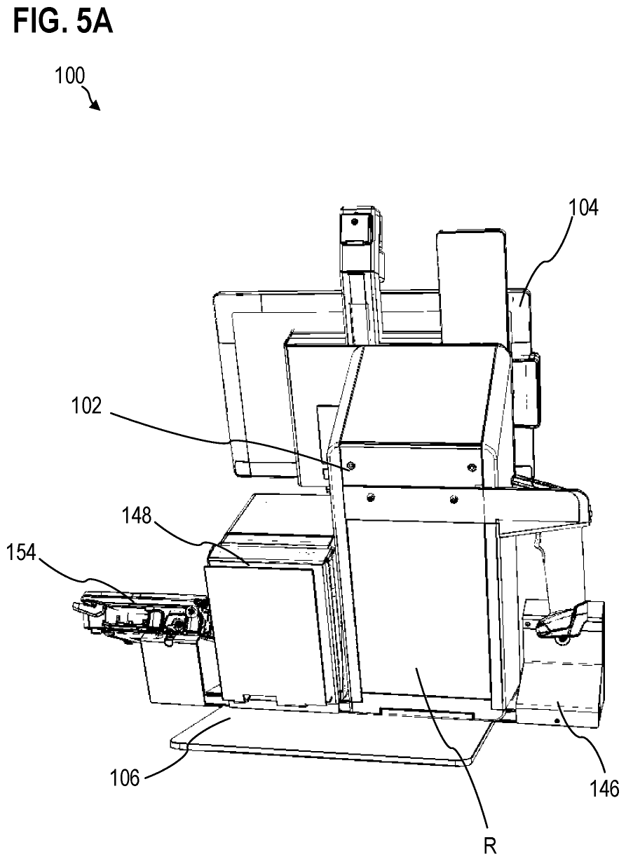

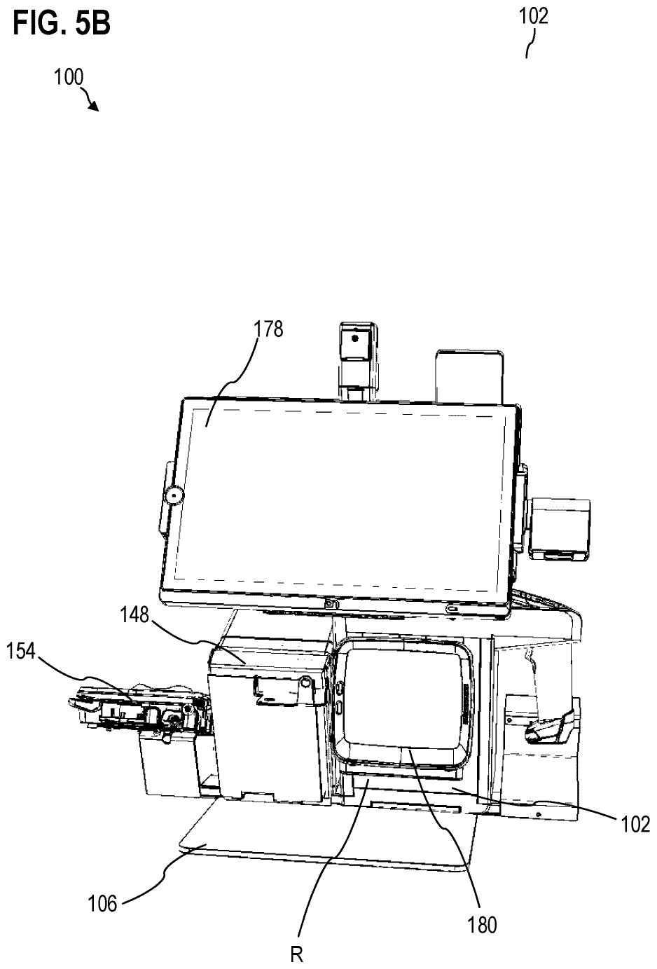

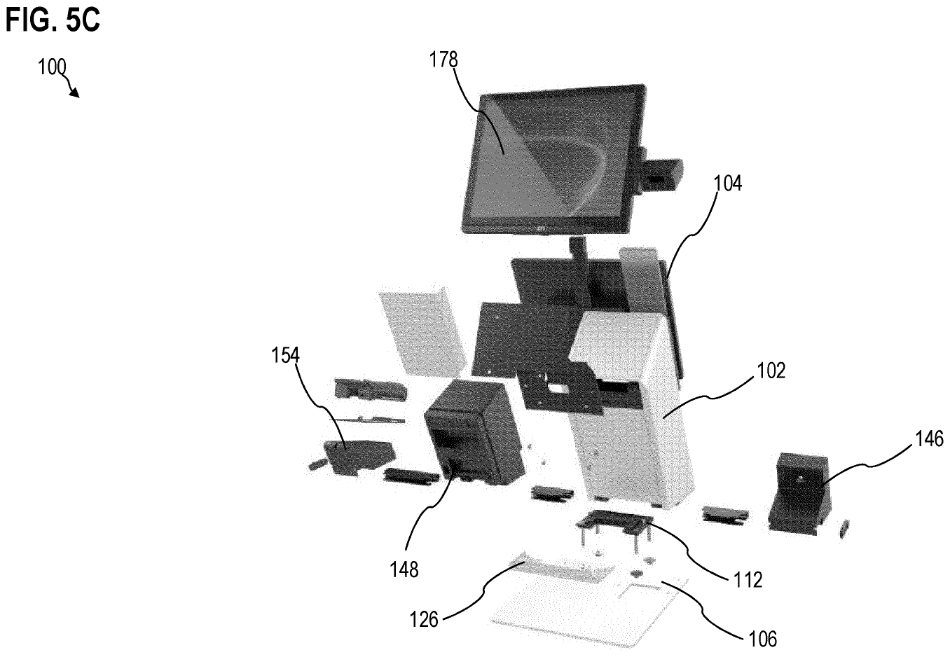

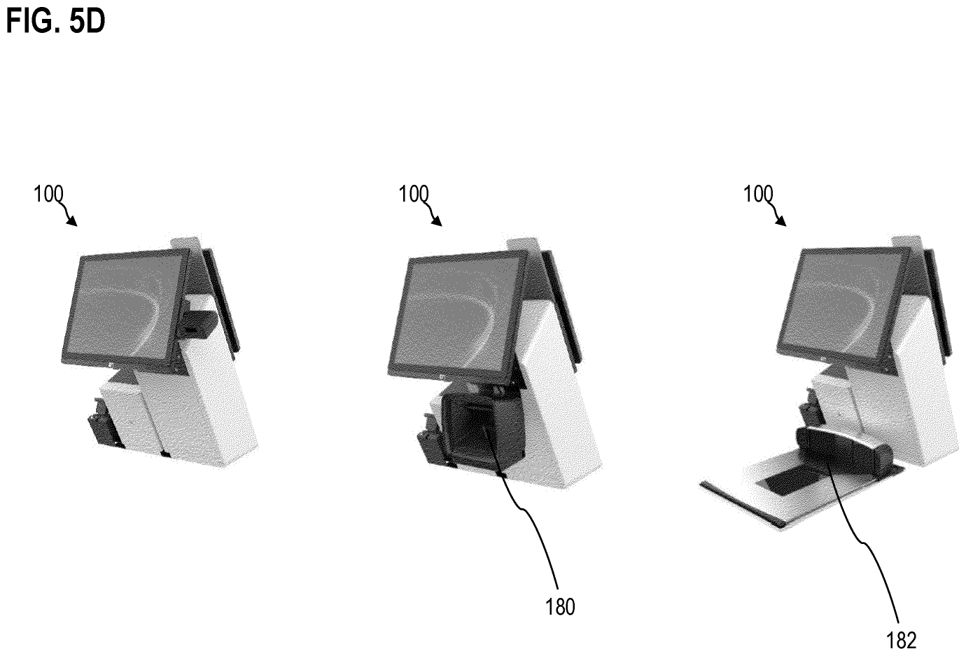

In some embodiments, the housing 102 may be configured to stand substantially perpendicular to the base 106. In other embodiments, the housing 102 may be configured, as shown in FIG. 1C, for example, to stand on the base 106 at an angle 107 less than or equal to 80° (e.g., less than or equal to 75°, e.g., less than or equal to 70°, etc.). Illustratively, in this case, the rear side, R, of the housing 102 can define a rear side plane that extends at an angle 107 less than or equal to 80° to a lower side plane defined by the lower side, and the front side, V, of the housing 102 can define a front side plane that extends from the lower side, U, towards the upper side, O, inclined backwards (i.e., away from the user). Illustratively, the housing 102 can be inclined obliquely backwards. This may, for example, allow a display and/or control device facing an operator to be provided on the rear side, R, of the housing 102 (see, for example, FIG. 5B to FIG. 5D). Furthermore, this leads to a shift in the center of gravity of the self-service terminal 100, which, for example, in the case where a fastening element fastens the housing 102 to the base 106 in a section of the lower side, U, adjacent to the front side, V, of the housing 102, increases the stability of the self-service terminal 100.

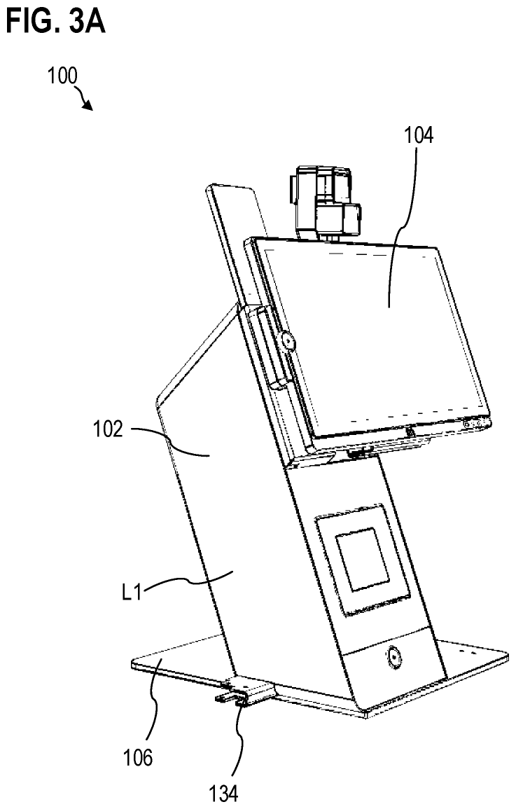

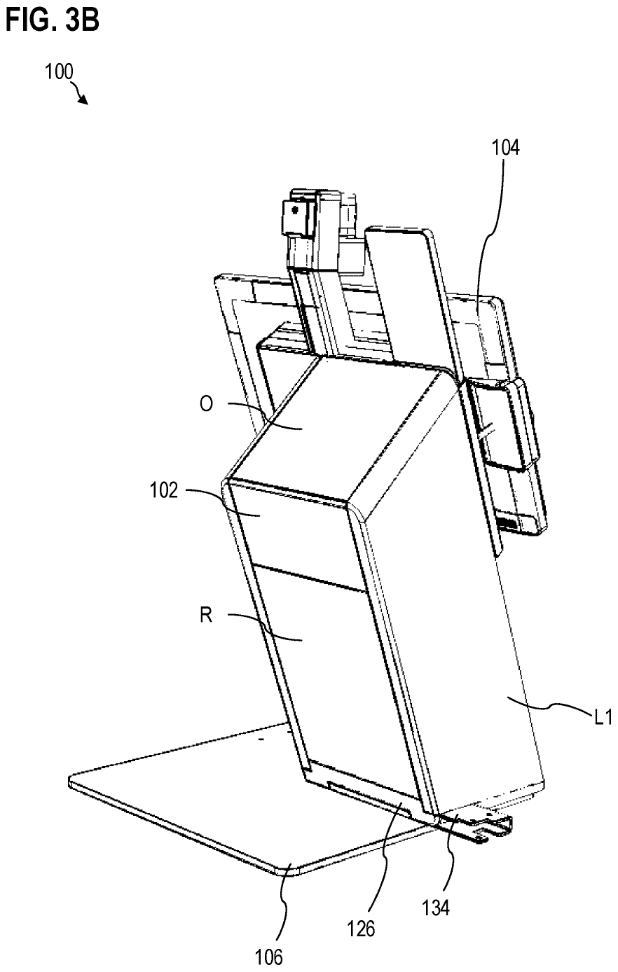

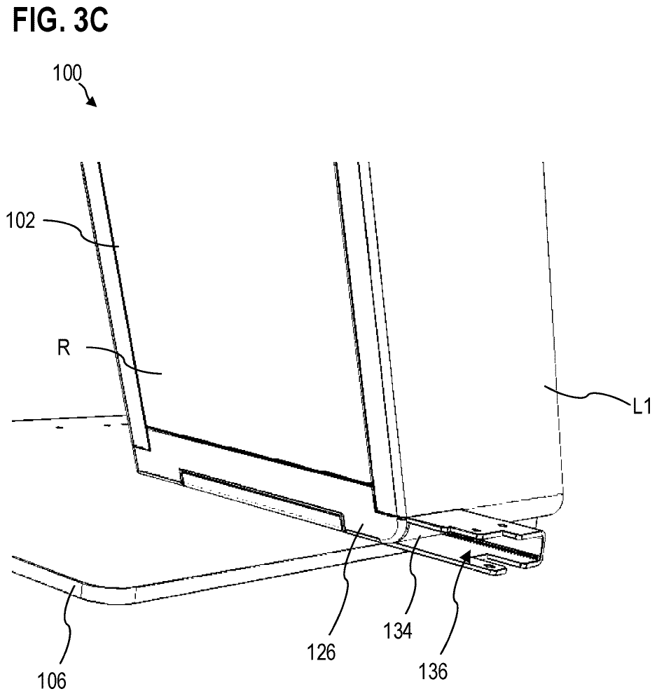

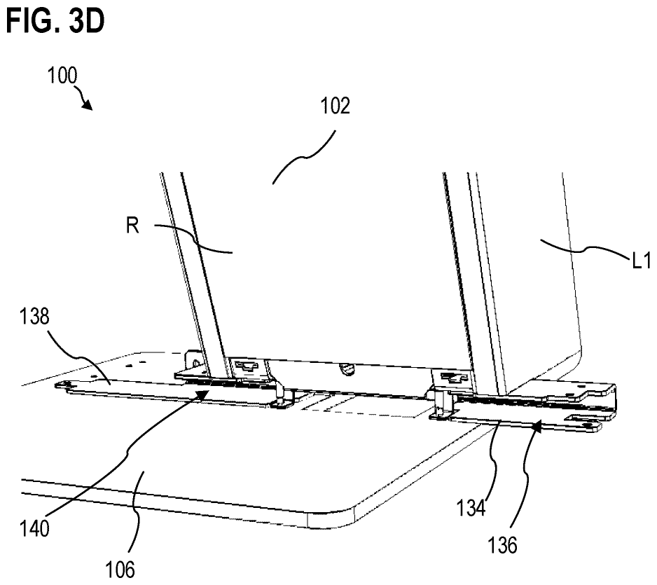

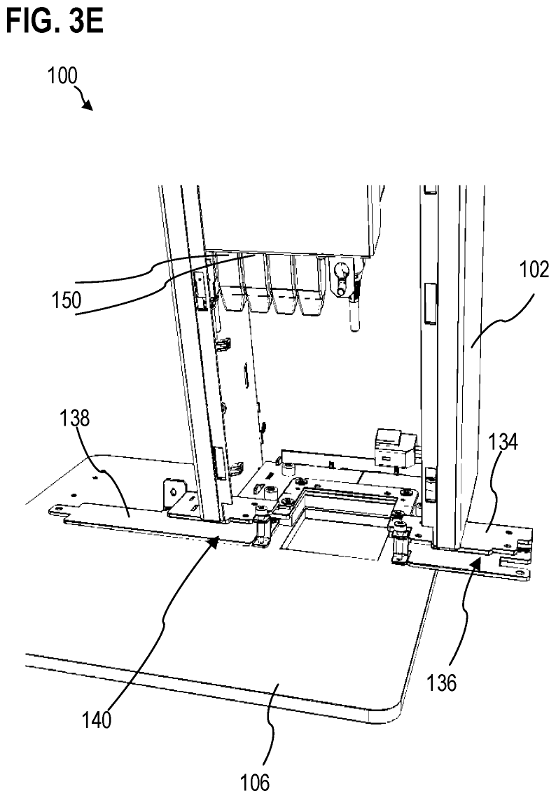

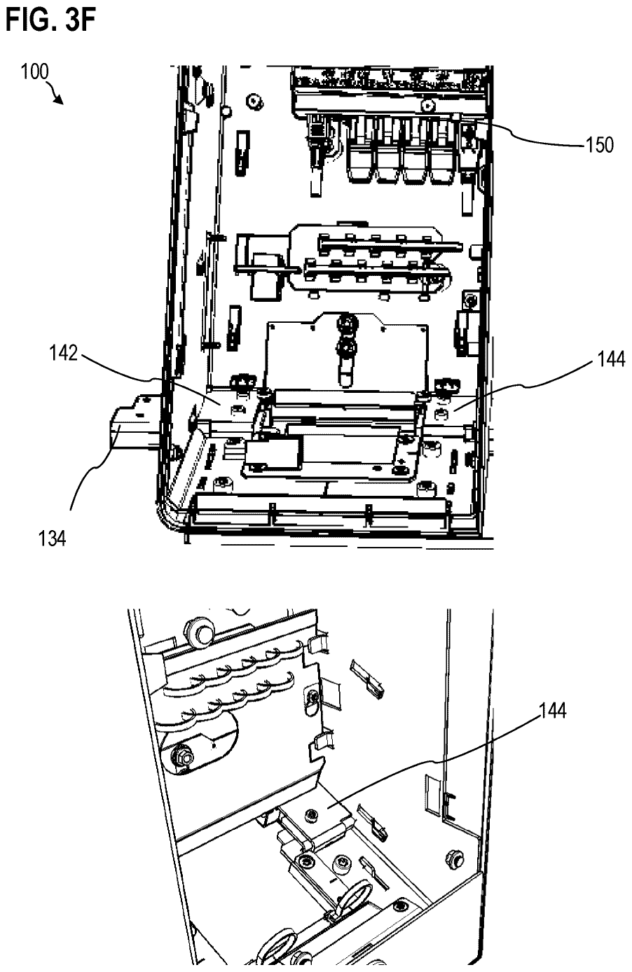

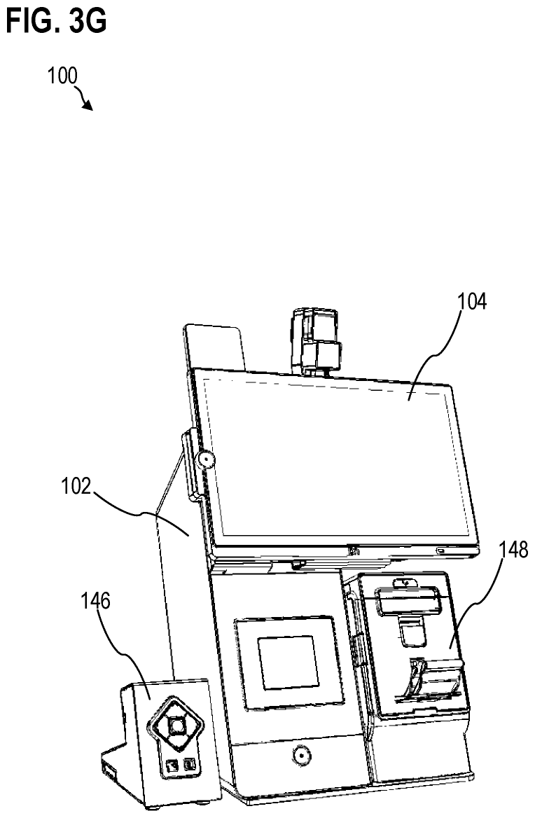

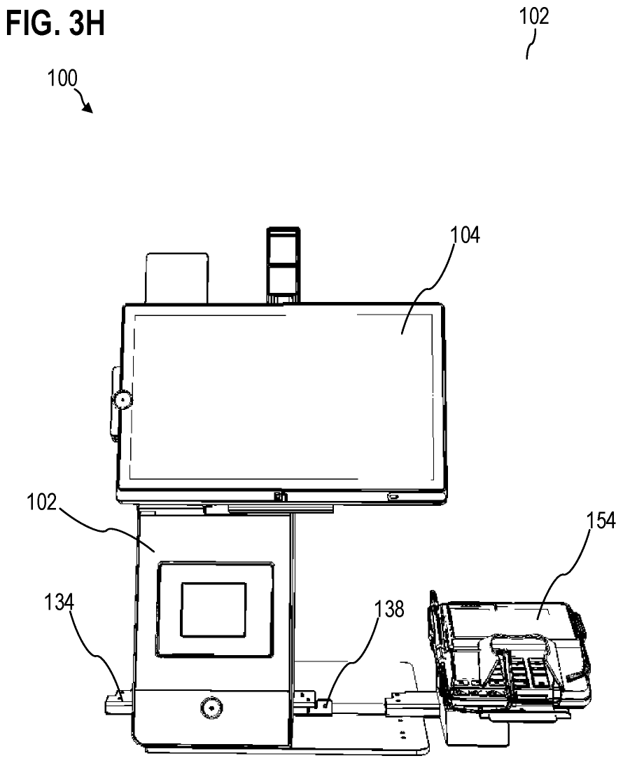

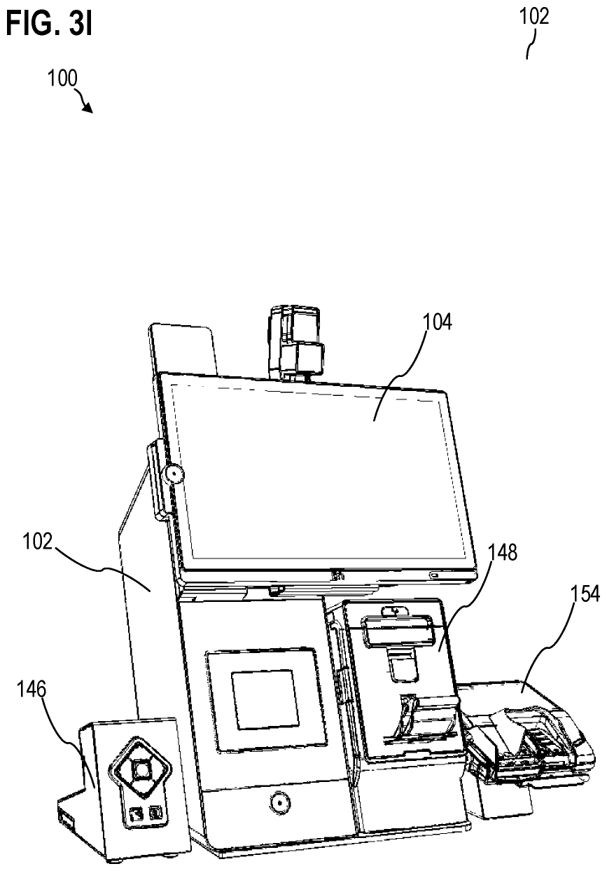

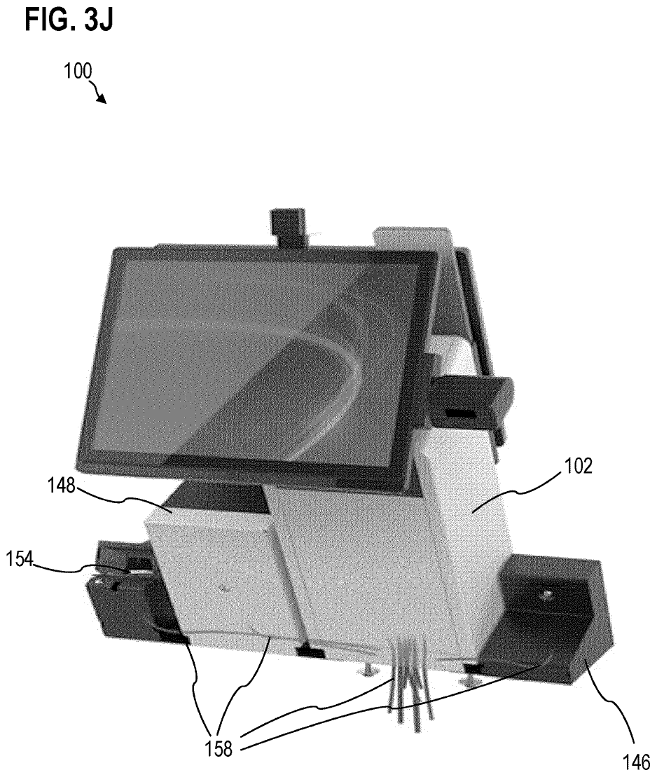

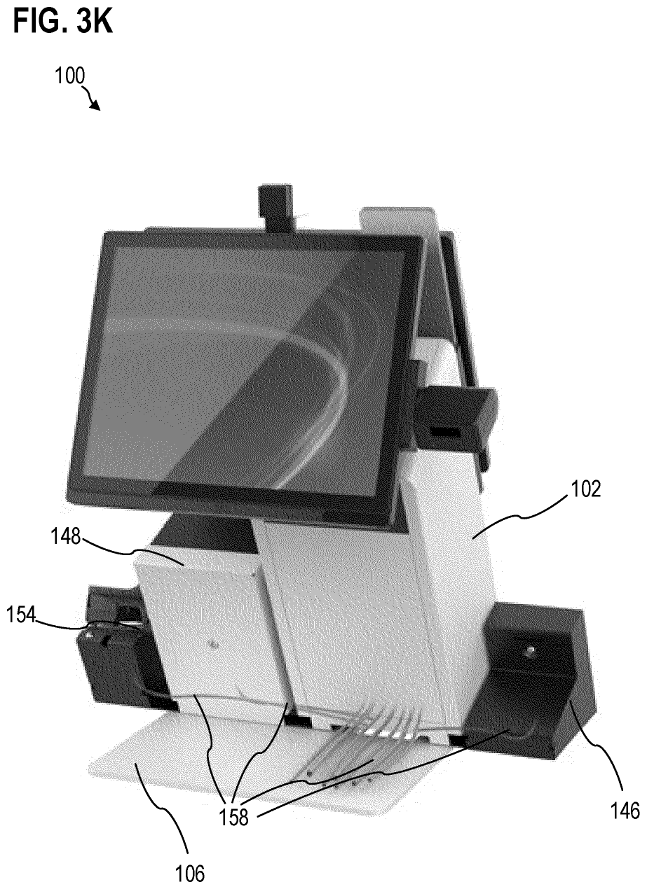

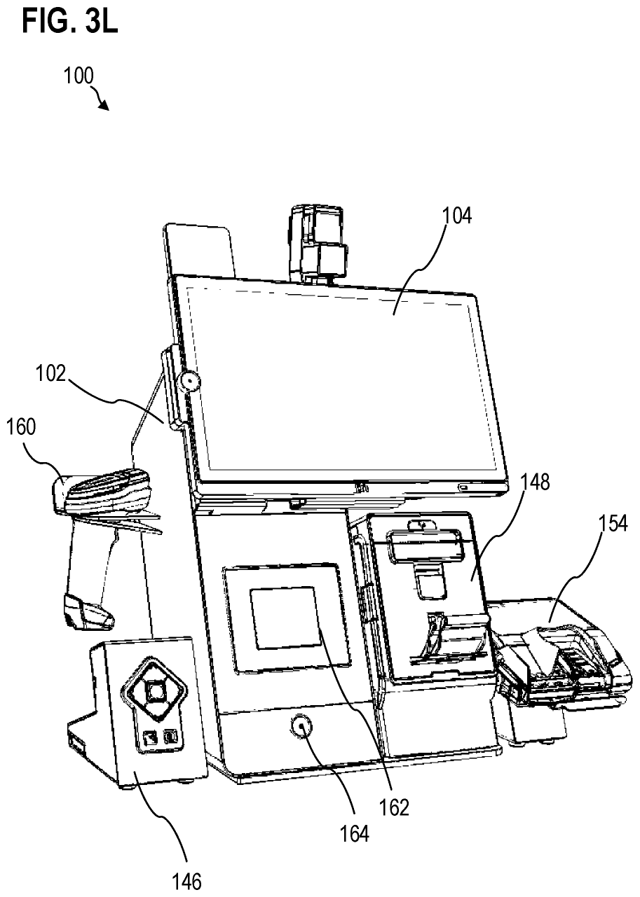

In the embodiments of the self-service terminal 100 shown in FIG. 1E and FIG. 1F, the housing 102 of the self-service terminal 100 is connected to one or more peripheral devices. According to various embodiments, the housing 102 can be configured such that it can be connected to at least one peripheral device by means of a connecting element. Exemplary embodiments of the self-service terminal 100 in this regard are described, for example, with reference to FIG. 3A to FIG. 3L.

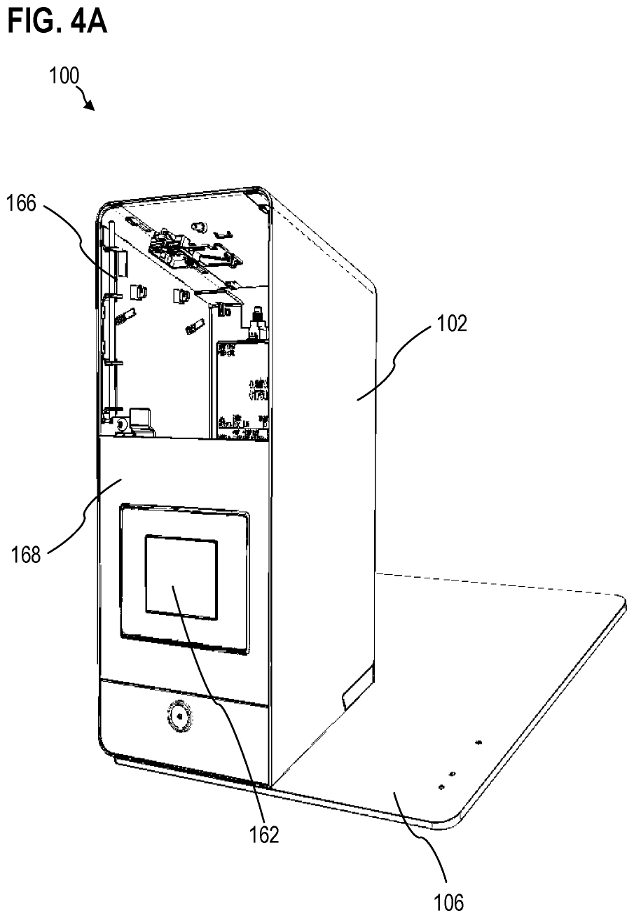

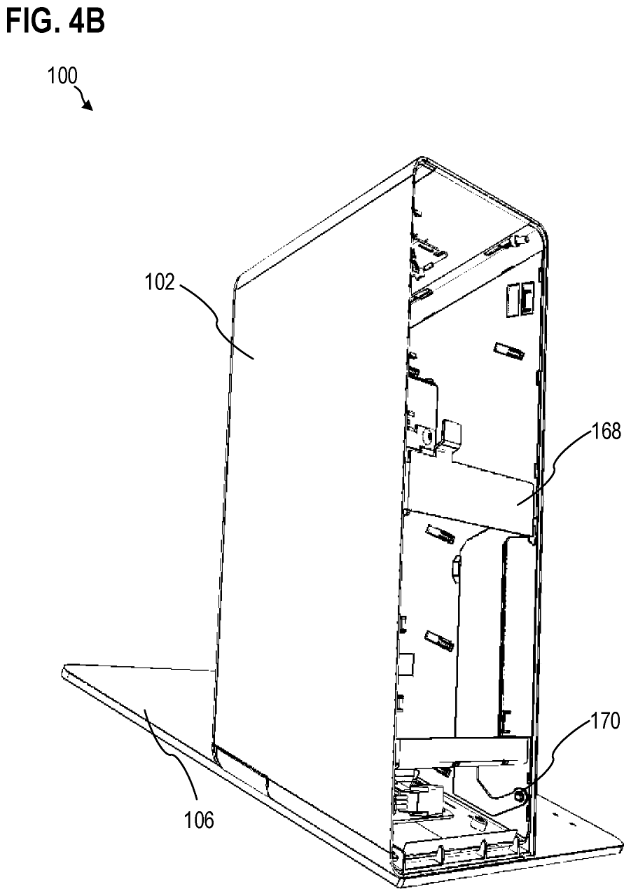

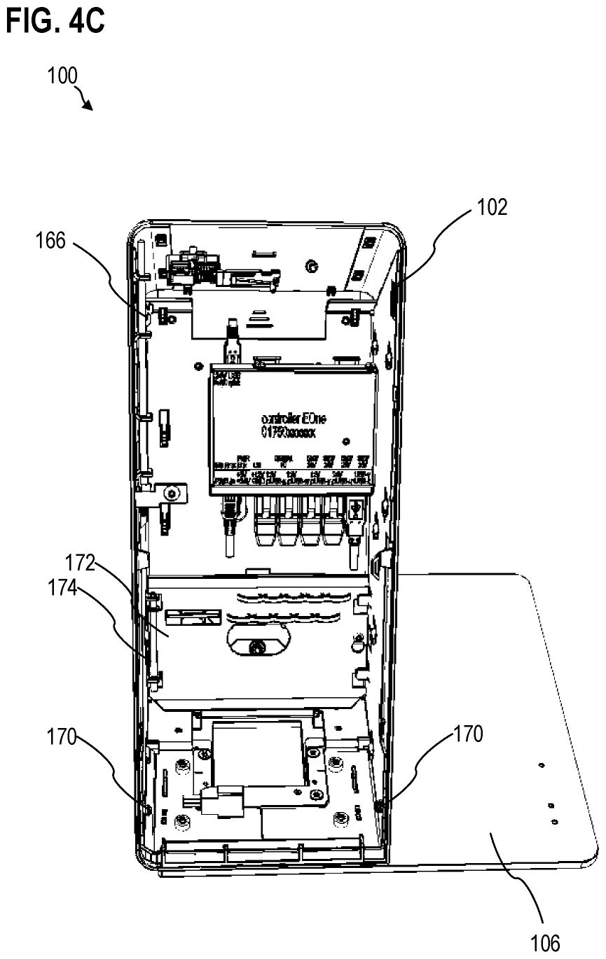

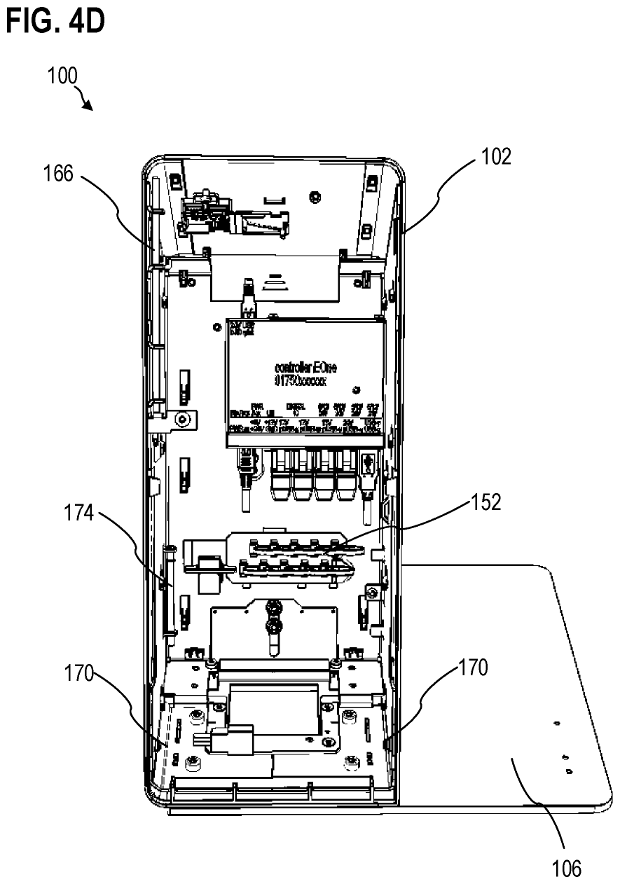

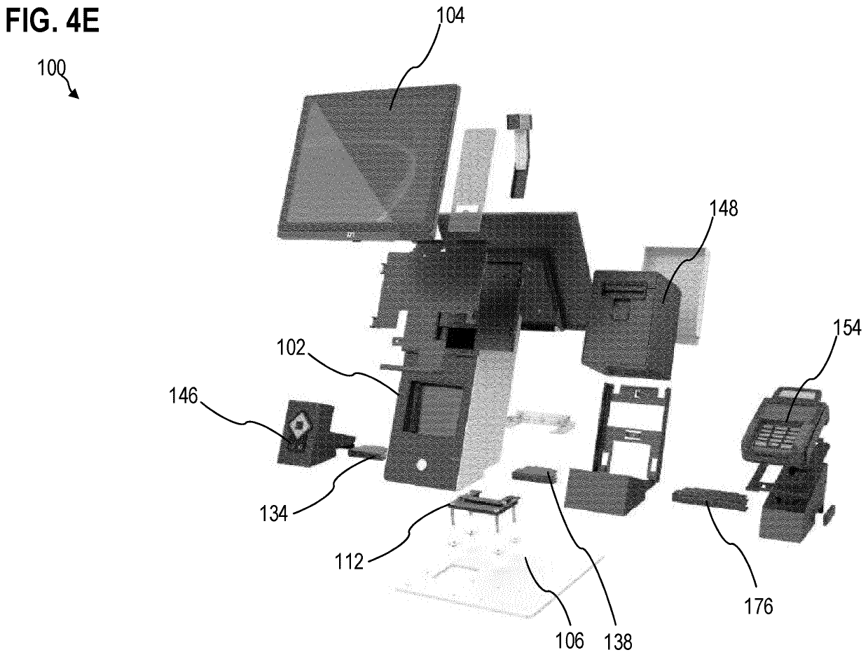

It may also be necessary and/or desirable to enable easy maintenance of the self-service terminal 100. According to various embodiments, the self-service terminal 100 may have various pivoting mechanisms that enable (e.g., step-wise) opening of the housing 102 in a simple manner. Embodiments of the self-service terminal 100 in this regard are described, for example, with reference to FIG. 4A to FIG. 4E.

According to various embodiments, the housing 102 can be formed on a side not facing the user of the self-service terminal 100 (e.g., the lower side, U, or the rear side, R) with a first linear insertion guide section and a second linear insertion guide section, which can be linearly inserted into a first correspondence linear insertion guide section and a second correspondence linear insertion guide section of a fastening element for assembling the self-service terminal 100 in order to detachably fix the housing 102 to the base 106 by fastening the fastening element to the base 106.

In order to be mountable on the wall, W, as shown, for example, in FIG. 1F, the housing 102 may have the first linear insertion guide section and the second linear insertion guide section at its rear side, R. For example, to be fastened to a standing base 106, the housing 102 may have the first linear insertion guide section and the second linear insertion guide section on its lower side, U. In the following, with reference to FIG. 2A to FIG. 2E, the housing 102 is described by way of example for the case in which the housing 102 is formed on its lower side, U, with a first linear insertion guide section 108 and a second linear insertion guide section 110. It is understood that the described aspects may also apply correspondingly to the case where the first linear insertion guide section and the second linear insertion guide section are formed on the rear side, R, of the housing 102. In this case, the housing 102 may be directly fastened to the wall, W, and/or may be fastened with the rear side to the base 106 and the base 106 may then be fastened to the wall, W. Referring to FIG. 2A, the self-service terminal 100 may include a fastening element 112. The fastening element 112 may be configured to be detachably fastened to the base 106 (e.g., screwed to the base 106 by means of one or more screws).

FIG. 2B shows an exemplary embodiment of the housing 102. The first linear insertion guide section 108 and the second linear insertion guide section 110 may run parallel to each other. This can define a common linear insertion direction 114. The first linear insertion guide section 108 and the second linear insertion guide section 110 can be arranged at a distance from one another or from one another transversely to the linear insertion direction 114. As shown in FIG. 2B, the first linear insertion guide section 108 and the second linear insertion guide section 110 may be formed, for example, in a section of the lower side, U, adjacent to the front side, V. Thus, as shown, a section of the lower side, U, adjacent to the rear side, R, may be free of the first linear insertion guide section 108 and the second linear insertion guide section 110. As described herein, the housing 102 may each have a lateral side recess (e.g., a first lateral side recess on the first lateral side and/or a second lateral side recess on the second lateral side) on the first lateral side, L1, and the second lateral side, L2, at a section adjacent to the rear side, R, whereby, for example, the section of the lower side, U, adjacent to the rear side, R, may also be free of the first linear insertion guide section 108 and the second linear insertion guide section 110 (see, for example, FIG. 2B). The housing 102 may have at least one opening 116 between the first linear insertion guide section 108 and the second linear insertion guide section 110. The at least one opening 116 can, for example, serve to pass through connecting cables (see, for example, FIG. 2A and FIG. 2C).

Referring to FIG. 2A, the fastening element 112 may have a first correspondence linear insertion guide section and a second correspondence linear insertion guide section. The first correspondence linear insertion guide section of the fastening element 112 may correspond to the first linear insertion guide section 108 of the housing 102. The second correspondence linear insertion guide section of the fastening element 112 may correspond to the second linear insertion guide section 110 of the housing 102. To assemble the self-service terminal 100, the housing 102 can therefore be linearly inserted along the linear insertion direction 114 with the first linear insertion guide section 108 and the second linear insertion guide section 110 into the first correspondence linear insertion guide section and the second correspondence linear insertion guide section of the fastening element 112, respectively. As a result, the housing 102 can be detachably fixed to the base 106 via the fastening element 112. According to various embodiments, the fastening element 112 can be additionally fastened to the base 106 during assembly of the self-service terminal 100 after the linear insertion of the housing 102, for example to press the first linear insertion guide section 108 and the second linear insertion guide section 110 of the housing 102 onto the base 106 by means of the fastening element 112 by means of compressive force (e.g. to clamp the first linear insertion guide section 108 and the second linear insertion guide section 110 of the housing 102 between the fastening element 112 and the base 106). This can increase the stability of the self-service terminal 100 during operation (e.g., when operating the display and/or control device 104 configured as a touchscreen). Additionally or alternatively, the fastening element 112 can be detachably fastened to the housing 102 (e.g., screwed by means of one or more screws).

According to various embodiments, the housing 102 may include a housing recess 124 at a section of the rear side, R, adjacent to the lower side, U (see, for example, FIG. 2A and FIG. 2B). Optionally, the housing recess 124 may extend into a section of the first lateral side, L1, adjacent to the lower side, U, and/or into a section of the second lateral side, L2, adjacent to the lower side, U (see, for example, FIG. 2A and FIG. 2B). Clearly, the housing recess may have the first lateral side recess and/or the second lateral side recess. The first lateral side recess on the section of the first lateral side, L1, adjacent to the lower side, U, and/or the second lateral side recess on the section of the second lateral side, L2, adjacent to the lower side, U, can serve to pass through a respective connecting element by means of which at least one peripheral device can be mechanically connected to the housing 102 (see, for example, FIG. 3A to FIG. 3L and the associated description).

FIG. 2C shows a rear view of a housing 102 fastened to the base 106 by means of the fastening element 112 (wherein the rear side, R, of the housing 102 and optional components of the self-service terminal 100 are hidden).

For example, as shown in FIG. 2A, FIG. 2C and FIG. 2D, the base 106 may have a base opening 118 for passing connecting cables. In some embodiments, the fastening element 112 can have one or more fastening element openings which, when the fastening element 112 is fastened to the base 106, can be arranged to at least partially overlap the base opening 118 of the base 106, so that connecting cables from the housing 102 can be passed through the one or more fastening element openings of the fastening element 112 and through the base opening 118 of the base 106 and/or so that connecting cables can be passed through the base opening 118 and through the one or more fastening element openings. Additionally or alternatively, the fastening element 112 may have a fastening element recess 120. The fastening element recess 120 may face the rear side, R, of the housing 102 when the housing 102 is detachably fixed to the base 106 via the fastening element 112. The fastening element recess 120 may be arranged to at least partially overlap the base opening 118 of the base 106 so that connecting cables from the housing 102 can be passed through the fastening element recess 120 and through the base opening 118 and/or so that connecting cables can be passed through the base opening 118 and through the fastening element recess 120. FIG. 2E shows on the left side a housing 102 fastened to the base 106 by means of the fastening element 112, in which the connecting cable 122 is passed through the fastening element recess 120 and through the base opening 118.

According to various embodiments, the fastening element recess 120 of the fastening element 112 allows the connecting cables 122 to be passed at least partially through the fastening element recess 120 and through the rear section of the housing recess 124 of the housing 102. FIG. 2E shows on the right side a housing 102 fastened to the base 106 by means of the fastening element 112, in which the connecting cables 122 are passed through the fastening element recess 120 and through the rear section of the housing recess 124. It can be clearly seen that the fastening element recess 120 can make it possible to lead the connecting cables 122 out of the housing 102 or into it through the rear section of the housing recess 124 and/or to lead them out of the housing 102 or into it through the base opening 118 in the base 106. This provides, for example, flexibility for operator-specific applications: If, for example, the pedestal (without base opening 118) is used as the base unit, the connecting cables 122 can be routed through the rear section of the housing recess 124. If a base unit with a cash module is used, one or more connecting cables can be passed through the base opening 118 (for example, to connect components of the cash module to a controller provided in the housing 102 and/or to pass connecting cables through and out of the base unit (or into the housing 102 by means of the base unit).

Optionally, the self-service terminal 100 can have a (e.g. rear) cover element 126 (cover for short, e.g. a cover flap). The cover element 126 may be configured to be detachably attached to the housing 102 so as to cover at least a section of the housing recess 124 (e.g., substantially the entire recess 124). For example, the cover element 126 can be loosened (e.g., removed) to pass the connecting cables 122 through the housing recess 124, as shown in FIG. 2E. As shown in FIG. 1B, the cover element 126 may have a first section 128 and a second section 130 which is different from the first section 128 and is integrally connected to the first section 128. The second section 130 may, when the cover element 126 is detachably attached to the housing 102, be disposed adjacent to the lower side, U, of the housing 102. The first section 128 and the second section 130 of the cover element 126 may be connected to one another by means of one or more predetermined breaking points. This increases the flexibility of use of the self-service terminal 100: If, for example, the connecting cables 122 are passed through the opening 118, the cover element 126 can serve to cover the recess 124. If at least one of the connecting cables 122 is to be passed through the rear section of the housing recess 124, the second section 130 of the cover element 126 can be separated from the first section 128 by means of the one or more predetermined breaking points. In this case, the first section 128 can be detachably attached to the housing 102 and the at least one of the connecting cables 122 can be passed through the cover element recess of the cover element 126 created by separating the second section of the cover element 126.

In addition to the flexibility described herein, the fastening element 112 also enables a self-service terminal 100 with a reduced cross-section (and consequently a reduced space requirement). The described (flexible) arrangement of the connecting cables and the reduction of the cross-section are made possible by the fastening element 112 described herein; a filler material for stabilizing the housing 102 would not make this possible.

As described above, the housing 102 can be modularly expandable. FIG. 3A to FIG. 3L each show aspects of this modular expandability of the self-service terminal 100. In this way, peripheral devices can be flexibly mechanically connected to the housing 102 (and optionally further connected thereto via connecting cables) in order, for example, to add a peripheral device and/or to remove a peripheral device and/or to exchange a peripheral device with another peripheral device and/or to change a respective position of already mechanically connected peripheral devices. In one example, during use of the self-service terminal 100, it may be determined that a verification device (as a peripheral device) is desired and/or required, and the self-service terminal 100 described herein allows for (subsequent) modular expansion by adding the verification device. In another example, during use of the self-service terminal 100, it may be determined that the position of a card reader (as a peripheral device) is causing confusion among users (e.g., customers), and the self-service terminal 100 described herein allows for (subsequent) changing of the position of the card reader.

A peripheral device as described herein may be any type of device that a self-service terminal 100 may use, for example, that may support a user's self-service process and/or that may provide security of the self-service terminal 100. For example, a peripheral device can be one of the following devices: a (e.g., receipt) printer, a mobile, handheld and/or stationary (e.g., barcode) scanner, a camera, a card reader, an operator device, a verification device (e.g., using facial recognition, fingerprint recognition, etc.), a scale, etc.

As described herein, the housing 102 may include a first lateral side recess at a section of the first lateral side, L1, adjacent to the lower side, U, and/or a second lateral side recess at a section of the second lateral side, L2, adjacent to the lower side, U; and optionally, these may be part of the housing recess 124. For illustrative purposes, the self-service terminal 100 is described below as having the first lateral side recess and the second lateral side recess as part of the housing recess 124. It is understood that the description also applies accordingly to the housing 102 having either the first or the second lateral side recess, and also to the first lateral side recess and/or the second lateral side recess being formed at a different position in the housing 102 or not being part of the housing 124.

The first lateral side recess and/or the second lateral side recess can be configured such that a connecting element 134 for mechanically connecting a peripheral device to the housing 102 can be passed through them into the housing 102. The housing 102 may be formed adjacent to the first lateral side recess with a first receptacle corresponding to the connecting element 134, to which the connecting element 134 can be fastened in order to thereby be fastened to the housing 102. The housing 102 may be formed adjacent to the second lateral side recess with a second receptacle corresponding to the connecting element 134, to which the connecting element 134 (or another connecting element configured corresponding to the connecting element 134) can be fastened in order to thereby be fastened to the housing 102.

The housing 102 may have a first panel on the first lateral side, L1, which is materially connected to the housing 102 in one piece. The housing 102 may have a second panel on the second lateral side, L2, which is materially connected to the housing 102 in one piece. The first panel and/or the second panel can be connected to the housing by means of one or more predetermined breaking points. This increases the flexibility of use of the self-service terminal 100: If no connecting element 134 is connected, the first cover can serve to cover the first lateral side recess, and the second cover can serve to cover the second lateral side recess. If a connecting element 134 for mechanically connecting the housing 102 to a peripheral device is to be passed through the first lateral side recess (or the second recess), the first panel (or the second panel) can be separated from the first section 128 by means of the one or more predetermined breaking points in order to be able to pass the connecting element 134 through the first (or second) lateral side recess.

Alternatively, the cover element 126 may have a third section 132 that is materially connected to the first section 128 in one piece (see, for example, FIG. 1B). The third section 132 may, when the cover element 126 is detachably attached to the housing 102, at least partially cover the first lateral side recess and/or the second lateral side recess. For example, the third section 132 may be connected to the first section 128 by means of one or more predetermined breaking points. This increases the flexibility of use of the self-service terminal 100: If no connecting element 134 is connected, the cover element 126 can serve to cover the housing recess 124. If a connecting element 134 for mechanically connecting the housing 102 to a peripheral device is to be passed through the first lateral side recess (or the second lateral side recess), the third section 132 of the cover element 126, which at least partially covers the first lateral side recess (or the second lateral side recess), can be separated from the first section 128 by means of the one or more predetermined breaking points. In this case, the first section 128 may be removably attached to the housing 102 and the connecting element 134 may be passed through the first lateral side recess (or the second lateral side recess).

FIG. 3A and FIG. 3B show different perspective views of the self-service terminal 100 to which the connecting element 134 is fastened. FIG. 3C to FIG. 3F each show a section of the self-service terminal 100 showing aspects of the connecting element 134 and/or the housing 102. In FIG. 3B, the cover element 126 covers the housing recess 124. In FIG. 3C, the cover element 126 is removed.

As shown in the sections shown in FIG. 3C and FIG. 3D, the connecting element 134 may have a passage space 136. When the connecting element 134 is fastened to the (first or second) receptacle, the passage space 136 can extend from outside the housing 102 through the (first or second) lateral side recess into the housing 102. This may allow one or more connecting cables of the peripheral device to be led from outside the housing 102 via the passage space 136 through the lateral side recess into the housing.

In the embodiment of the self-service terminal 100 shown in FIG. 3C, the connecting element 134 is passed through the first lateral side recess and mechanically connected to the housing 102. In the embodiment of the self-service terminal 100 shown in FIG. 3D, the connecting element 134 is a first connecting element 134 which is passed through the first lateral side recess and mechanically connected to the housing 102. In this case, the passage space 136 of the connecting element 134 can be a first passage space 136 for passing one or more connecting cables of a first peripheral device from outside the housing 102 via the first passage space 136 through the first lateral side recess into the housing 102. Furthermore, the embodiment according to FIG. 3D shows a second connecting element 138, which is passed through the second lateral side recess (in the second lateral side, L2) and is mechanically connected to the housing 102 by means of the second receptacle. The second connecting element 138 may have a second passage space 140 for passing one or more connecting cables of a second peripheral device from outside the housing 102 via the second passage space 140 through the second lateral side recess into the housing 102.

FIG. 3E shows a section of a rear view of the self-service terminal 100 with the rear of the housing 102 hidden and with the first receptacle and second receptacle hidden. FIG. 3F shows two sections of a front view of the self-service terminal 100 with the front of the housing 102 hidden in order to show, for example, the first receptacle 142 and/or the second receptacle 144. The first receptacle 142 and/or the second receptacle 144 may be part of the housing 102. It is understood that a connecting element can also be additionally or alternatively mechanically connected (e.g. screwed) to the fastening element 112.

According to various embodiments, the self-service terminal 100 may have a plurality of connection locations 150 in the housing 102 for connecting electrical devices. For example, electrical devices connected to and/or integrated into the housing 102 may be connected to one or more of the connection locations 150. According to various aspects, at least one connecting cable of a peripheral device mechanically connected to the housing 102 by means of the connecting element 134, 138 can be guided through the passage space 136, 140 of the connecting element 134, 138 into the housing 102 and can be connected to one of the plurality of connection locations 150. For this purpose, the self-service terminal 100 can, for example, have at least one cable guide 152 for guiding the at least one connecting cable. The at least one cable guide 152 can be arranged in the housing 102 between the plurality of connection locations 150 and the lower side of the housing (i.e. below the plurality of connection locations 150). Optionally, the at least one cable guide 152 may be mechanically connected to the rear of the housing 102. Illustratively, the plurality of connection locations 150 may be located closer to the top than to the bottom of the housing 102.

FIG. 3G shows an embodiment of the self-service terminal 100 in which a first peripheral device 146 (e.g., a verification device) is mechanically connected to the housing 102 by means of the first connecting element 134 and a second peripheral device 148 (e.g., a receipt printer) is mechanically connected to the housing 102 by means of the second connecting element 138.

According to various embodiments, multiple peripheral devices can be mechanically connected to the housing 102 by means of one and the same receptacle.

In some aspects, the connecting element may be configured to connect to multiple peripheral devices. As shown in FIG. 3H by way of example for the second connecting element 138, the connecting element can be configured such that, when it is mechanically connected to a peripheral device (e.g., the second peripheral device 146), a section of the connecting element is exposed (i.e., not covered by the peripheral device), so that this section can be mechanically connected to another peripheral device (e.g., a third peripheral device 154), so that both peripheral devices can be fastened to the housing 102 by means of the connecting element. For example, the peripheral device may have a recess extending from a first side of the peripheral device to a second side of the peripheral device opposite the first side, through which the connecting element may extend. The peripheral device may have a receptacle corresponding to the connecting element, to which the connecting element can be fastened.

In other aspects, a peripheral device (e.g., the second peripheral device 146) may have a first device recess through which the connecting element can be passed, on a first side of the peripheral device, and a second device recess through which another connecting element for mechanically connecting the peripheral device to another peripheral device (e.g., the third peripheral device 154) can be passed, on a second side of the peripheral device opposite the first side. Illustratively, for example, the second peripheral device 146 can be mechanically attachable to the housing 102 by means of the second connecting element 138 and the third peripheral device 154 can be mechanically attachable to the second peripheral device 146 by means of a third connecting element, so as to be attachable to the housing 102 by means of the second peripheral device 146. For example, the second peripheral device 146 may have a first device recess and a first device receptacle corresponding to the first device recess, to which the connecting element is fastened, and a second device recess and a second device receptacle corresponding to the second device recess, to which the other connecting element can be fastened. The third connecting element can also have an associated passage space for passing through connecting cables of the third peripheral device 154.

FIG. 3I shows an exemplary embodiment of the self-service terminal 100 in which the housing 102 is mechanically connected to the first peripheral device 144, the second peripheral device 146 and the third peripheral device 154. This is clearly demonstrated by a modularly expanded self-service terminal 100.

As described herein, the connecting elements may each have a passage space for the passage of connecting cables. For example, at least one connecting cable of the third peripheral device 154 can be guided through the passage spaces into the housing 102, so that at least one connecting cable can be connected to a respective connection location of the plurality of connection locations 150. According to various embodiments, at least one connecting cable of a peripheral device can be guided through a passage space of a connecting element into the housing 102 and out of the housing 102 through the housing recess 124. FIG. 3J shows an exemplary cable routing of connecting cables 158 for passing through the opening 118 of the base 106. FIG. 3K shows an exemplary cable routing of connecting cables 158 through the rear section of the housing recess 124.

It is understood that the self-service terminal 100 may have other (e.g. additional) peripheral devices. For example, as shown in FIG. 3L, the self-service terminal 100 may include a holder 160 for a handheld scanner. Optionally, the self-service terminal 100 may have a stationary scanner unit 162 (e.g., for scanning bar codes). The stationary scanner unit 162 may, for example, be integrated into the front side, V, of the housing 102, as shown in FIG. 3L. Optionally, the self-service terminal 100 may, for example, have an access interface 164 for a Dallas key. It is understood that these are examples and the self-service terminal 100 may additionally or alternatively include various other peripherals, user interfaces, etc.

According to various embodiments, the self-service terminal 100 may have various pivoting mechanisms that enable (e.g., step-wise) opening of the housing 102 in a simple manner. The self-service terminal 100 can have corresponding swivel devices. FIG. 4A to FIG. 4D each show a section of the self-service terminal 100 (with several components hidden) in order to illustrate the various swivel devices.

The display and/or control device 104 (e.g. as part of a display and/or operating unit) can be pivotally attached to the housing 102 by means of a first pivoting device 166. The first pivoting device 166 may define a first pivot axis (about which the display and/or control device is pivotable). The first pivot axis 166 may extend at an angle of less than or equal to 30° (e.g., less than or equal to 20°, e.g., less than or equal to 10°, e.g., less than or equal to 5°) to the front side, V. For example, as shown in FIG. 4A, the first pivot axis 166 may extend substantially parallel to the front side, V, of the housing 102. The first pivot axis 166 may extend at an angle of less than or equal to 30° (e.g., less than or equal to 20°, e.g., less than or equal to 10°, e.g., less than or equal to 5°) to the vertical axis. For example, the first pivot axis 166, as shown in FIG. 4A, may be substantially parallel to the vertical axis of the housing 102. Clearly, the display and/or control device 104 can be pivoted by means of the first pivoting device 166 from a working position in which it is located on the front side of the housing 102 into a pivoted-out position in which it is pivoted away towards a lateral side (e.g. the first lateral side, L1) of the housing 102.

The housing 102 may be provided on the front side, V, with a front opening (in some aspects also referred to as a housing opening). The self-service terminal 100 may include a front cover element 168. The front cover element 168 may be pivotally attached to the housing 102 by means of a second pivoting device 170 (see, for example, FIG. 4C). The second pivoting device 170 can define a second pivot axis. The second pivot axis may extend transversely to the first pivot axis. The second pivot axis may extend at an angle of less than or equal to 30° (e.g., less than or equal to 20°, e.g., less than or equal to 10°, e.g., less than or equal to 5°) to the front side of the housing 102. For example, as shown in FIG. 4C, the second pivot axis may be substantially parallel to the front face (e.g., to a front face plane defined by the front face). Clearly, the front side cover element 168 can be pivoted by means of the second pivoting device 170 from a covering position in which it is located on the front side above the front side opening (in order to cover it at least partially (e.g. completely)) into an opening position in which it is pivoted forward away from the front side.

As shown, the first pivot device 166 may be located closer to the top, O, of the housing 102 than to the bottom, U. The second pivot device 170 may be located closer to the bottom, U, of the housing 102 than to the top, O.

Clearly, the display and/or control device 104 can be pivoted away in the lateral direction by means of the first pivoting device and the front cover element 168 can be pivoted away forward (in the direction of the user) by means of the second pivoting device 170.

By pivoting the front cover element 168 away, the front opening on the front of the housing 102 can be exposed, providing access into the housing 102 (e.g., for maintenance work, for releasing a mechanically connected fastening element, for mechanically fastening a fastening element to an associated receptacle of the housing 102, etc.).

As shown in FIG. 4A, the self-service terminal 100 may optionally include the stationary scanner unit 162, which may be integrated into the front cover element 168. In this case, the stationary scanner unit 162 can be pivoted together with the front cover element 168. According to various embodiments, the self-service terminal 100 may include an antenna unit. The antenna unit may be mechanically connected to the front cover element 168. The antenna unit may at least partially (e.g. completely) surround the scanner unit. For example, the scanner unit 162 and/or the antenna unit may be configured such that they do not protrude beyond a front plane defined by a front side of the front cover element 168 (towards the user). For example, when the front cover element 168 is in the cover position, the antenna unit can enable the user to detect and/or invalidate radio frequency, electromagnetic, and/or acoustomagnetic tags and/or radio frequency identification (RFID) tags (e.g., for an Electronic Article Surveillance (EAS) system) during the self-service process at the self-service terminal.

According to various embodiments, the self-service terminal 100 (e.g., the display and/or control device 104 and the front cover element 168) can be configured such that the display and/or control device 104, in the working position, blocks pivoting of the front cover element 168 from the covering position into the opening position and that the display and/or control device 104, in the pivoting-out position, does not block pivoting of the front cover element 168 from the covering position into the opening position. This may provide a two-stage opening of the housing 102 such that the front cover element 168 can only be pivoted away if the display and/or control device 104 is first pivoted away. In this way, the display and/or control device 104 and the front cover element 168 can be arranged at least partially superimposed from the direction of the user, which results, for example, in a reduced space requirement of the self-service terminal 100. In this way, the pivoting of both the display and/or control device 104 and the front cover element 168 can also be secured by means of a single locking/unlocking mechanism in that the locking/unlocking mechanism can lock the first pivoting device 166 (which also blocks the second pivoting device 170). For example, the locking-unlocking mechanism may be configured to unlock the first pivoting device 166 by means of a mechanical and/or digital key.

Alternatively or in addition to the first pivoting device 166 and the second pivoting device 170, the self-service terminal 100 may have a third pivoting device 174. The self-service terminal 100 may have a cover flap 172. The cover flap 172 may be arranged in the housing 102. The cover flap 172 can be mechanically connected to the housing 102 by means of the third pivoting device 174 and can be pivotally attached thereto. The third pivoting device 174 may define a third pivot axis. The third pivot axis may extend at an angle of less than or equal to 30° (e.g., less than or equal to 20°, e.g., less than or equal to 10°, e.g., less than or equal to 5°) to the front side, V. For example, as shown in FIG. 4C and FIG. 4D, the third pivot axis may extend substantially parallel to the front side V of the housing 102 (e.g., optionally substantially parallel to the first pivot axis). The third pivot axis may extend at an angle of less than or equal to 30° (e.g., less than or equal to 20°, e.g., less than or equal to 10°, e.g., less than or equal to 5°) to the vertical axis. For example, the third pivot axis can run essentially parallel to the vertical axis.

The cover flap 172 can be configured to at least partially (e.g. completely) cover one or more cable guides 152 (for guiding connecting cables). Thus, the cover flap 172 can be pivoted by means of the third pivoting device 174 from a covering position, in which the one or more cable guides 152 are at least partially covered from the direction of the user, into a covering position in which the one or more cable guides 162 are not covered from the direction of the user. In this way, the connecting cables can be routed in a section within the housing 102 adjacent to the rear of the housing 102 and thus do not block, for example, maintenance work when access to the interior of the housing 102 is provided by pivoting the display and/or control device 104 and pivoting the front cover element 168. The cable routing in the section adjacent to the rear of the housing 102 can be made possible by the arrangement described herein using the fastening element 112 and/or the cable guide in the modular extension through the recesses formed in the section of the respective lateral side adjacent to the rear.

FIG. 4E shows an exploded view of an exemplary embodiment of the self-service terminal 100 in which the self-service terminal 100 includes, among other things, the fastening element 112 for fastening to the base 106, the first connecting element 134, the second connecting element 138 and a third connecting element 176 for mechanically connecting the self-service terminal 100 to the first peripheral device 146, the second peripheral device 148 and the third peripheral device 154, as well as the first pivot mechanism 166 and the second pivot mechanism 170.

The self-service terminal 100 may be used exclusively for self-service in some applications (e.g., in a grocery store). In this case, for example, the rear side, R, of the self-service terminal 100, as shown in FIG. 5A, may be substantially free of peripheral devices. Illustratively, the devices connected to the self-service terminal 100 can be oriented towards the user to support the self-service process of the user (e.g., customer).

In other applications, the self-service terminal 100 may include one or more peripheral devices on the rear side, R, of the housing 102. The one or more peripheral devices may, for example, be directed toward an operator (who may monitor and/or control and/or assist the user's self-service process). In some embodiments, the self-service terminal 100 may not include the one or more peripheral devices, but may be configured to be expandable with rear peripheral devices. Illustratively, the front side of the self-service terminal 100 may be a user side and the rear side of the self-service terminal 100 may be an employee side (e.g., an assistant side). FIG. 5B shows an exemplary embodiment of the self-service terminal 100 in which the self-service terminal 100 has a display and/or control device 178 (e.g., a touchscreen) on the side facing away from the user (e.g., facing the employee or another user). Furthermore, the self-service terminal 100 may have a stationary scanner unit 180 (e.g., mechanically connected to the rear side, R, of the housing 102). FIG. 5C shows an exemplary exploded view (similar to FIG. 4E) of the self-service terminal 100 looking toward the rear, R. It is understood that these are examples and that the self-service terminal 100 may include any peripheral devices facing away from the user (e.g., facing the attendant). As an example, as shown in FIG. 5D, a scanner unit with integrated scale 182 may be arranged on the attendant side. According to various embodiments, the front side of the self-service terminal 100 may be a first user side for a self-service process of a first user (e.g., a first customer) and the rear side of the self-service terminal 100 may be a second user side for a self-service process of a second user (e.g., a second customer). In this case, the rear side can also be mechanically connected and/or mechanically connectable to corresponding peripheral devices (e.g. a second display and/or control device, a second scanner unit, etc.). Clearly, the self-service terminal 100 can provide hybrid functionality (e.g., for a customer and an employee).

The self-service terminal 100 described herein offers increased flexibility due to its modular expandability and can thus reduce costs on the operator side (e.g., the operator's total operating costs) because costly adaptations are not required (e.g., if adaptation of the structure or additional peripheral devices are required). The reduced cross-section and the resulting reduced space requirement can further reduce costs. Due to the reduced cross-section, the self-service terminal 100 can be used, for example, as a self-service kiosk (e.g. on a table) even when space is limited.

Various aspects of the self-service terminal 100 are described herein. It is understood that the principles described herein may also be embodied as corresponding methods. For example, a method of assembling a self-service terminal may include attaching a fastening element to a base and linearly inserting two linear insertion guide sections of a housing of the self-service terminal into associated correspondence linear insertion guide sections of the fastening element. A method for assembling a self-service terminal may also comprise inserting a connecting element into a recess of a housing of the self-service terminal and fastening the connecting element to a receptacle of the self-service terminal (and optionally further fastening at least one peripheral device to the connecting element).

Examples are described below that illustrate various aspects of the self-service terminal 100.
Example 1 is a self-service terminal comprising: a housing with a first side facing a user of the self-service terminal and a second side not facing the user of the self-service terminal, wherein the housing is formed on the second side with a first linear insertion guide section and a second linear insertion guide section, which run parallel to one another and thus define a common linear insertion direction and which are arranged at a distance from one another transversely to the linear insertion direction, and wherein the housing is provided with at least one opening between the two linear insertion guide sections for the passage of connecting cables; a display and/or control device attached to the housing and oriented towards the user of the self-service terminal; one or more processors configured to provide a graphical display and/or operating interface on the display and/or control device in order to assist the user in a self-service process at the self-service terminal; a fastening element configured to be detachably fastened to a base and having first and second correspondence linear insertion guide sections corresponding to the first and second linear insertion guide sections of the housing, such that the housing and the fastening element fastened to the base are assemblable along the linear insertion direction via linear insertion, thereby detachably securing the housing to the base via the fastening element.
Example 2 is configured according to example 1, wherein the first side is a front side of the housing and wherein the second side is a lower side of the housing.
Example 3 is configured according to example 2, wherein the housing has a upper side opposite the lower side, wherein the front side extends between the lower side and the upper side, wherein the front side extends at an angle of less than or equal to 80°, optionally less than or equal to 70°, to the lower side and extends inclined rearward towards the upper side.
Example 4 is configured according to example 2 or 3, wherein the fastening element has a fastening element recess which, when the housing is detachably secured to the base via the fastening element, faces a rear side of the housing opposite the front side, so that the connecting cables can be guided through the fastening element recess into a base opening of the base corresponding to the fastening element recess and/or through the fastening element recess and a housing recess formed on a section of the rear side adjacent to the lower side, in order to be guided out of the housing.
Example 5 is a self-service terminal according to any one of examples 2 to 4, wherein the housing has a rear side opposite the front side, wherein the first linear insertion guide section and the second linear insertion guide section of the housing are formed on the bottom in a section adjacent to the front side and not in a section adjacent to the rear side.
Example 6 is configured according to any one of examples 2 to 5, wherein the fastening element has a fastening element opening such that the connecting cables can be passed through the fastening element opening into a base opening of the base corresponding to the fastening element opening. Example 7 is configured according to any one of examples 2 to 6, wherein the housing has a rear side opposite the front side and is provided with a housing recess (or the recess when in combination with Example 4) at least on a section of the rear side adjacent to the lower side.
Example 8 is configured according to example 7, wherein the housing has a first lateral side extending between the front and the back and laterally thereto, and a second lateral side opposite the first lateral side, wherein the housing recess further extends into a section of the first lateral side adjacent to the bottom and the back and/or into a section of the second lateral side adjacent to the bottom and the back.
Example 9 is a self-service terminal according to example 7 or 8, further comprising: a cover element configured to be detachably attached to the housing to at least partially (e.g., completely) cover the housing recess.
Example 10 is a self-service terminal according to any one of examples 2 to 9, wherein the housing has a rear side opposite the front side, which faces another user of the self-service terminal (e.g., another customer or an attendant), and wherein the self-service terminal further comprises another display and/or control device attached to the housing and directed toward the other user of the self-service terminal. The one or more processors may, for example, be configured to provide a graphical display and/or operating interface on the other display and/or control device (to assist the other user in a self-service process at the self-service terminal and/or to enable an attendant as another user to assist the user in the self-service process at the self-service terminal). Optionally, the self-service terminal can have additional peripherals at the rear, such as another scanner unit (facing the other user).
Example 11 is configured according to example 1, wherein the first side is a front side of the housing and wherein the second side is a rear side of the housing opposite the front side.
Example 12 is configured according to example 11, wherein the housing has a housing recess on a third side extending between the front and the back, on a section of the third side adjacent to the back.
Example 13 is a self-service terminal according to any one of examples 1 to 12, wherein the display and/or control device comprises a touchscreen.
Example 14 is configured according to one of examples 1 to 13, wherein the housing has, on a third side, which adjoins the first side and the second side, on a section of the third side adjoining the second side, a connecting element connection housing recess through which a connecting element for mechanically connecting a peripheral device to the self-service terminal, optionally to the housing, can be passed into the housing, wherein the housing is formed adjacent to the connecting element connection housing recess with a receptacle corresponding to the connecting element, to which the connecting element can be fastened in order to be fastened to the housing
Example 15 is the self-service terminal according to example 14, which further comprises the connecting element.
Example 16 is configured according to example 15, wherein the connecting element has a passage space which, when the connecting element is fastened to the receptacle, extends from outside the housing through the connecting element connection housing recess into the housing, thereby enabling one or more connecting cables of the peripheral device to be guided from outside the housing via the passage space through the connecting element connection housing recess into the housing.
Example 17 is a self-service terminal according to example 15 or 16, further comprising a peripheral device mechanically connected to the self-service terminal, optionally to the housing, by means of the connecting element.
Example 18 is configured according to example 17, wherein the peripheral device comprises one of the following peripheral devices: a printer, a (e.g., bar code) scanner, a camera, a card reader, an operator device, a verification device (e.g., by means of facial recognition, fingerprint recognition, etc.), a scale, etc.
Example 19 is a self-service terminal according to example 17 or 18, wherein the peripheral device has a first device recess, through which the connecting element passes, on a first side of the peripheral device and a second device recess, through which another connecting element for mechanically connecting the peripheral device to another peripheral device can be passed, on a second side of the peripheral device opposite the first side, wherein the peripheral device is formed with a first receptacle corresponding to the first device recess, to which the connecting element is fastened, and a second receptacle corresponding to the second device recess, to which the other connecting element can be fastened, such that the other peripheral device can be fastened to the self-service terminal, optionally to the housing, by means of the peripheral device.
Example 20 is configured according to example 17 or 18, wherein the peripheral device has a device recess which extends from a first side to a second side opposite the first side and through which the connecting element extends such that a section of the connecting element adjacent to the second side is not covered by the peripheral device, wherein the section of the connecting element is attachable to another peripheral device for mechanically connecting the other peripheral device to the self-service terminal, optionally to the housing.
Example 21 is configured according to any one of examples 14 to 20, wherein the connecting element connection housing recess is provided with a cover which is integrally connected to the third side of the housing, optionally by means of one or more predetermined breaking points.
Example 22 is configured according to any one of examples 14 to 20, if in combination with Example 9, wherein the connecting element connection housing recess is part of the housing recess and wherein the connecting element connection housing recess is formed in the section of the first lateral side adjacent to the lower side and the rear side or in the section of the second lateral side adjacent to the lower side and the rear side, wherein the cover element has a first section which at least partially covers the section of the housing recess extending into the rear side, and a second section which at least partially covers the connecting element connection housing recess, wherein the first section and the second section of the cover element are materially connected to one another in one piece by means of one or more predetermined breaking points.
Example 23 is configured according to any one of examples 14 to 22, wherein the housing has, on a fourth side opposite the third side, on a section of the fourth side adjacent to the second side, another connecting element connection housing recess through which another connecting element for mechanically connecting another peripheral device to the self-service terminal, optionally to the housing, can be passed into the housing, wherein the self-service terminal, optionally the housing, is formed adjacent to the other connecting element connection housing recess with another receptacle corresponding to the other connecting element, to which the other connecting element can be fastened in order to thereby be fastened to the self-service terminal, optionally the housing.
Example 24 is the self-service terminal according to example 23, which further comprises the other connecting element and the other peripheral device, wherein the other peripheral device has a different first device recess, through which the other connecting element passes, on a first side of the other peripheral device and a different second device recess, through which yet another connecting element for mechanically connecting the peripheral device to yet another peripheral device can pass, on a second side of the other peripheral device opposite the first side, wherein the other peripheral device is provided with a further first receptacle corresponding to the other first device recess, to which the other connecting element is fastened, and a second receptacle corresponding to the other second device recess, to which the further connecting element can be fastened, so that the further peripheral device can be fastened by means of the other peripheral device to the self-service terminal, optionally to the housing.
Example 25 is the self-service terminal of example 24, further comprising the other connecting element and the other peripheral device, wherein the other peripheral device has an other device recess extending from a first side to a second side opposite the first side, through which the other connecting element extends such that a section of the other connecting element adjacent to the second side is not covered by the other peripheral device, wherein the section of the other connecting element is attachable to yet another peripheral device for mechanically connecting the yet another peripheral device to the self-service terminal, optionally to the housing.
Example 26 is configured according to any one of examples 16 to 25, when combined with Example 16, further comprising: a plurality of connection locations within the housing for connecting electrical devices; wherein at least one connecting cable of the one or more connecting cables can be guided through the connecting element connection housing recess into the housing and connected to a connection location of the plurality of connection locations; at least one cable guide for guiding the at least one connecting cable, wherein the at least one cable guide is arranged in the housing between the plurality of connection locations and the connecting element connection housing recess of the housing and is mechanically connected to a side of the housing opposite the first side.
Example 27 is the self-service terminal according to example 26, further comprising: a cover flap for at least partially covering the at least one connecting cable guided in the at least one cable guide; a (third) pivoting device, by means of which the cover flap is pivotably attached to the housing and which defines a pivot axis which extends in a direction which is parallel to or at an angle of less than or equal to 30°, optionally less than or equal to 10°, or further optionally less than or equal to 5°, to a first-side plane defined by the first side, such that the cover flap can be pivoted by means of the pivoting device from a covering position, in which the at least one cable guide is at least partially covered from the direction of the first side, into an uncovering position, in which the at least one cable guide is not covered from the direction of the first side.
Example 28 is configured according to example 26 or 27, wherein the first side is a front side extending between a top and a bottom of the housing, wherein the plurality of terminal locations are closer to the top than to the bottom.
Example 29 is the self-service terminal according to any one of examples 26 to 28, when in combination with Example 8, further comprising a plurality of cable guides adjacent to the at least one cable guide for guiding connecting cables from the connection locations through the housing recess out of the housing.
Example 30 is configured according to any one of examples 1 to 29, wherein the housing has a upper side and a lower side, and wherein the first side is a front side extending between the upper side and the lower side, defining a front side plane, and wherein the housing is provided with a housing opening on the front side; and wherein the self-service terminal further comprises: a first pivoting device, by means of which the display and/or control device is pivotably attached to the housing and which defines a first pivot axis which extends in a direction which is parallel to or at an angle of less than or equal to 30°, optionally less than or equal to 10°, or further optionally less than or equal to 5°, to the front plane and parallel to or at an angle of less than or equal to 30°, optionally less than or equal to 10°, or further optionally less than or equal to 5°, to the vertical axis, so that the display and/or control device can be pivoted by means of the first pivoting device from a working position in which it is located on the front of the housing into a pivoted-out position in which it is pivoted away towards a lateral side of the housing; a front cover element; a second pivoting device, by means of which the front side cover element is pivotably attached to the housing and which defines a second pivot axis which runs transversely to the first pivot axis and parallel to or at an angle of less than or equal to 30°, optionally less than or equal to 10°, or further optionally less than or equal to 5°, to the front side plane, so that the front side cover element can be pivoted by means of the second pivoting device from a covering position in which it is located on the front side above the opening in order to at least partially cover it, into an opening position in which it is pivoted forwards away from the front side.
Example 31 is a self-service terminal comprising: a housing having a first side facing a user of the self-service terminal and a second side not facing the user of the self-service terminal; a display and/or control device attached to the housing and oriented toward the user of the self-service terminal; one or more processors configured to provide a graphical display and/or operating interface on the display and/or control device to assist the user in a self-service process at the self-service terminal; wherein the housing has, on a third side, which adjoins the first side and the second side, on a section of the third side adjoining the second side, a connecting element connection housing recess through which a connecting element for mechanically connecting a peripheral device to the self-service terminal, optionally to the housing, can be passed into the housing, wherein the self-service terminal, optionally the housing, is formed adjacent to the connecting element connection housing recess with a receptacle corresponding to the connecting element, to which the connecting element can be fastened in order to thereby be fastened to the self-service terminal, optionally to the housing.
Example 32 is the self-service terminal according to example 31, which further comprises the connecting element.
Example 33 is configured according to example 32, wherein the connecting element has a passage space which, when the connecting element is fastened to the receptacle, extends from outside the housing through the connecting element connection housing recess into the housing, thereby enabling one or more connecting cables of the peripheral device to be guided from outside the housing via the passage space through the connecting element connection housing recess into the housing.
Example 34 is a self-service terminal according to example 32 or 33, further comprising a peripheral device mechanically connected to the self-service terminal, optionally to the housing, by means of the connecting element.
Example 35 is configured according to example 34, wherein the peripheral device comprises one of the following peripheral devices: a printer, a (e.g., bar code) scanner, a camera, a card reader, an operator device, a verification device (e.g., by means of facial recognition, fingerprint recognition, etc.), a scale, etc.
Example 36 is a self-service terminal according to example 34 or 35, wherein the peripheral device has a first device recess, through which the connecting element passes, on a first side of the peripheral device and a second device recess, through which another connecting element for mechanically connecting the peripheral device to another peripheral device can be passed, on a second side of the peripheral device opposite the first side, wherein the peripheral device is formed with a first receptacle corresponding to the first device recess, to which the connecting element is fastened, and a second receptacle corresponding to the second device recess, to which the other connecting element can be fastened, such that the other peripheral device can be fastened to the self-service terminal, optionally to the housing, by means of the peripheral device.
Example 37 is configured according to example 34 or 35, wherein the peripheral device has a device recess which extends from a first side to a second side opposite the first side and through which the connecting element extends such that a section of the connecting element adjacent to the second side is not covered by the peripheral device, wherein the section of the connecting element is attachable to another peripheral device for mechanically connecting the other peripheral device to the self-service terminal, optionally to the housing.
Example 38 is configured according to any one of examples 31 to 37, wherein the connecting element connection housing recess is provided with a panel which is integrally connected to the third side of the housing, optionally by means of one or more predetermined breaking points.
Example 39 is a self-service terminal according to any one of examples 31 to 38, wherein the connecting element terminal housing recess is part of a housing recess which further extends into a section of the second side adjacent to the third side, and wherein the self-service terminal optionally further comprises a cover element which is configured to be detachably fastened to the housing in order to at least partially (e.g. completely) cover the housing recess, wherein the cover element has a first section which at least partially covers the section of the housing recess extending into the second side, and a second section which at least partially covers the connecting element terminal housing recess, wherein the first section and the second section of the cover element are materially connected to one another in one piece by means of one or more predetermined breaking points.
Example 40 is configured according to any one of examples 31 to 39, wherein the housing has, on a fourth side opposite the third side, on a section of the fourth side adjacent to the second side, another connecting element connection housing recess through which another connecting element for mechanically connecting another peripheral device to the self-service terminal, optionally to the housing, can be passed into the housing, wherein the housing is formed adjacent to the other connecting element connection housing recess with another receptacle corresponding to the other connecting element, to which the other connecting element can be fastened in order to thereby be fastened to the self-service terminal, optionally the housing.
Example 41 is the self-service terminal according to example 40, which further comprises the other connecting element and the other peripheral device, wherein the other peripheral device has a different first device recess, through which the other connecting element passes, on a first side of the other peripheral device and a different second device recess, through which yet another connecting element for mechanically connecting the peripheral device to yet another peripheral device can pass, on a second side of the other peripheral device opposite the first side, wherein the other peripheral device is provided with a further first receptacle corresponding to the other first device recess, to which the other connecting element is fastened, and a second receptacle corresponding to the other second device recess, to which the further connecting element can be fastened, so that the further peripheral device can be fastened by means of the other peripheral device to the self-service terminal, optionally to the housing.
Example 42 is the self-service terminal of example 40, further comprising the other connecting element and the other peripheral device, wherein the other peripheral device has an other device recess extending from a first side to a second side opposite the first side, through which the other connecting element extends such that a section of the other connecting element adjacent to the second side is not covered by the other peripheral device, wherein the section of the other connecting element is attachable to yet another peripheral device for mechanically connecting the yet another peripheral device to the self-service terminal, optionally to the housing.
Example 43 is configured according to any one of examples 31 to 42, wherein the housing is formed on the second side with a first linear insertion guide section and a second linear insertion guide section, which run parallel to one another and thus define a common linear insertion direction and which are arranged at a distance from one another transversely to the linear insertion direction, and wherein the housing is provided with at least one opening for the passage of connecting cables between the two linear insertion guide sections; and wherein the self-service terminal further comprises a fastening element which is configured to be detachably fastened to a base and which has a first and a second correspondence linear insertion guide section which correspond to the first and the second linear insertion guide section of the housing, such that the housing and the fastening element fastened to the base can be assembled along the linear insertion direction via linear insertion, in order to thereby detachably fix the housing to the base via the fastening element.
Example 44 is configured according to example 43, wherein the first side is a front side of the housing and wherein the second side is a lower side of the housing.
Example 45 is configured according to example 44, wherein the housing has a upper side opposite the lower side, wherein the front side extends between the lower side and the upper side, wherein a front plane defined by the front side extends at an angle of less than or equal to 80°, optionally less than or equal to 70°, to a lower plane defined by the lower side and extends inclined rearward towards the upper side.
Example 46 is configured according to example 44 or 45, wherein the fastening element has a fastening element recess which, when the housing is detachably fixed to the base via the fastening element, faces a rear side of the housing opposite the front side, so that the connecting cables can be guided through the fastening element recess into a base opening of the base corresponding to the fastening element recess and/or through the fastening element recess and a rear side recess (e.g. as part of the housing recess, when in combination with example 39) formed on a section of the rear side adjacent to the lower side, in order to be guided out of the housing.
Example 47 is configured according to any one of examples 44 to 45, wherein the fastening element has a fastening element opening such that the connecting cables can be passed through the fastening element opening into a base opening of the base corresponding to the fastening element opening.
Example 48 is a self-service terminal according to any one of examples 44 to 46, wherein the housing has a rear side opposite the front side, wherein the first linear insertion guide section and the second linear insertion guide section of the housing are formed on the lower side in a section adjacent to the front side and not in a section adjacent to the rear side.
Example 49 is a self-service terminal according to any one of examples 31 to 48, wherein the housing has a rear side opposite the front side, which faces another user of the self-service terminal (e.g., another customer or an attendant), and wherein the self-service terminal further comprises another display and/or control device attached to the housing and directed toward the other user of the self-service terminal. The one or more processors may, for example, be configured to provide a graphical display and/or operating interface on the other display and/or control device (to assist the other user in a self-service process at the self-service terminal and/or to enable an attendant as another user to assist the user in the self-service process at the self-service terminal). Optionally, the self-service terminal can have additional peripherals at the rear, such as another scanner unit (facing the other user).
Example 50 is configured according to example 43, wherein the first side is a front side of the housing and wherein the second side is a rear side of the housing opposite the front side.
Example 51 is configured according to example 50, wherein the third side is a lower side of the housing.
Example 52 is a self-service terminal according to any one of examples 31 to 51, wherein the display and/or control device comprises a touchscreen.
Example 53 is a self-service terminal, comprising: a housing with a first side (e.g., front side) facing a user of the self-service terminal and a second side (e.g., rear side) opposite the first side; a display and/or control device attached to the housing and oriented toward the user; one or more processors configured to provide a graphical display and/or operating interface on the display and/or control device to assist the user in a self-service process at the self-service terminal; a plurality of connection locations within the housing for connecting electrical devices; wherein the housing has, on a third side extending between the first side and the second side, a housing recess on a section of the third side adjacent to the second side, through which recess at least one connecting cable can be passed for connecting a peripheral device arranged outside the housing to at least one connection location of the plurality of connection locations; at least one cable guide for guiding the at least one connecting cable, wherein the at least one cable guide is arranged in the housing between the plurality of connection locations and the housing recess and is mechanically connected to the second side of the housing.
Example 54 is the self-service terminal according to example 53, further comprising: a cover flap for at least partially covering the at least one connecting cable guided in the at least one cable guide; a pivoting device, by means of which the cover flap is pivotably attached to the housing and which defines the one pivot axis which extends in a direction which is parallel to or at an angle of less than or equal to 30°, optionally less than or equal to 10°, or further optionally less than or equal to 5°, to a first-side plane defined by the first side, such that the cover flap can be pivoted by means of the pivoting device from a covering position, in which the at least one cable guide is at least partially covered from the direction of the first side, into an uncovering position, in which the at least one cable guide is not covered from the direction of the first side.
Example 55 is configured according to example 53 or 54, wherein the first side is a front side extending between an upper and a lower side of the housing, wherein the plurality of terminal locations are closer to the upper side than to the lower side.
Example 56 is a self-service terminal according to any one of examples 53 to 55, further comprising a plurality of cable guides adjacent to the at least one cable guide for guiding connecting cables from the connection locations through another housing recess in the housing out of the housing.
Example 57 is configured according to any one of examples 53 to 56, wherein the housing recess is configured such that a connecting element for mechanically connecting the peripheral device to the self-service terminal, optionally to the housing, can be passed through it into the housing, wherein the self-service terminal, optionally the housing, is formed adjacent to the housing recess with a receptacle corresponding to the connecting element, to which the connecting element can be fastened in order to thereby be fastened to the self-service terminal, optionally to the housing; and wherein the connecting element has a passage space which, when the connecting element is fastened to the receptacle, extends from outside the housing through the housing recess into the housing, in order to thereby enable the at least one connecting cable of the peripheral device to be passed from outside the housing via the passage space through the housing recess into the housing.
Example 58 is the self-service terminal according to example 57, further comprising the connecting element.
Example 59 is a self-service terminal according to example 57 or 58, further comprising a peripheral device mechanically connected to the self-service terminal, optionally to the housing, by means of the connecting element.
Example 60 is configured according to example 59, wherein the peripheral device comprises one of the following peripheral devices: a printer, a (e.g., bar code) scanner, a camera, a card reader, an operator device, a verification device (e.g., by means of facial recognition, fingerprint recognition, etc.), a scale, etc.
Example 61 is a self-service terminal according to example 59 or 60, wherein the peripheral device has a first device recess, through which the connecting element passes, on a first side of the peripheral device and a second device recess, through which another connecting element for mechanically connecting the peripheral device to another peripheral device can be passed, on a second side of the peripheral device opposite the first side, wherein the peripheral device is formed with a first receptacle corresponding to the first device recess, to which the connecting element is fastened, and a second receptacle corresponding to the second device recess, to which the other connecting element can be fastened, such that the other peripheral device can be fastened to the self-service terminal, optionally to the housing, by means of the peripheral device.
Example 62 is configured according to example 59 or 60, wherein the peripheral device has a device recess which extends from a first side to a second side opposite the first side and through which the connecting element extends such that a section of the connecting element adjacent to the second side is not covered by the peripheral device, wherein the section of the connecting element can be fastened to another peripheral device for mechanically connecting the other peripheral device to the self-service terminal, optionally to the housing.
Example 63 is configured according to any one of examples 53 to 62, wherein the housing recess is provided with a panel that is integrally connected to the housing, optionally by means of one or more predetermined breaking points.
Example 64 is a self-service terminal according to any one of examples 53 to 62, wherein the second side is opposite the first side, the housing recess extends into a section of the second side adjacent to the third side, and wherein the self-service terminal optionally further comprises a cover element which is configured to be detachably fastened to the housing in order to at least partially (e.g. completely) cover the housing recess, wherein the cover element has a first section which at least partially covers the section of the housing recess extending into the second side, and a second section which at least partially covers the section of the housing recess extending into the third side, wherein the first section and the second section of the cover element are materially connected to one another in one piece by means of one or more predetermined breaking points.
Example 65 is configured according to any one of examples 53 to 64, wherein the housing has another housing recess on a fourth side opposite the third side on a section of the fourth side adjacent to the second side, or wherein the housing recess further extends into the section of the fourth side adjacent to the second side, wherein another connecting element for mechanically connecting another peripheral device to the self-service terminal, optionally to the housing, can be passed through the other housing recess or the housing recess into the housing, wherein the self-service terminal, optionally the housing, is formed adjacent to the other housing recess or the housing recess with another receptacle corresponding to the other connecting element, to which the other connecting element can be fastened in order to thereby be fastened to the self-service terminal, optionally to the housing.
Example 66 is the self-service terminal according to example 65, which further comprises the other connecting element and the other peripheral device, wherein the other peripheral device has a different first device recess, through which the other connecting element passes, on a first side of the other peripheral device and a different second device recess, through which yet another connecting element for mechanically connecting the peripheral device to yet another peripheral device can pass, on a second side of the other peripheral device opposite the first side, wherein the other peripheral device is provided with a further first receptacle corresponding to the other first device recess, to which the other connecting element is fastened, and another second receptacle corresponding to the other second device recess, to which the further connecting element can be fastened, so that the further peripheral device can be fastened by means of the other peripheral device to the self-service terminal, optionally to the housing.
Example 67 is the self-service terminal of example 65, further comprising the other connecting element and the other peripheral device, wherein the other peripheral device has an other device recess extending from a first side to a second side opposite the first side, through which the other connecting element extends such that a section of the other connecting element adjacent to the second side is not covered by the other peripheral device, wherein the section of the other connecting element is attachable to yet another peripheral device for mechanically connecting the yet another peripheral device to the self-service terminal, optionally to the housing.
Example 68 is configured according to any one of examples 53 to 67, wherein the housing is formed on the second side with a first linear insertion guide section and a second linear insertion guide section, which run parallel to one another and thus define a common linear insertion direction and which are arranged at a distance from one another transversely to the linear insertion direction, and wherein the housing is provided with at least one opening for the passage of connecting cables between the two linear insertion guide sections; and wherein the self-service terminal further comprises a fastening element which is configured to be detachably fastened to a base and which has a first and a second correspondence linear insertion guide section which correspond to the first and the second linear insertion guide section of the housing, such that the housing and the fastening element fastened to the base can be assembled along the linear insertion direction via linear insertion, in order to thereby detachably fix the housing to the base via the fastening element.
Example 69 is configured according to example 68, wherein the first side is a front side of the housing and wherein the second side is a lower side of the housing.
Example 70 is configured according to example 69, wherein the housing has an upper side opposite the lower side, wherein the front side extends between the lower side and the upper side, wherein a front plane defined by the front side extends at an angle of less than or equal to 80°, optionally less than or equal to 70°, to a lower plane defined by the lower side and extends inclined rearward towards the upper side.
Example 71 is configured according to example 69 or 70, wherein the fastening element has a fastening element recess which, when the housing is detachably fixed to the base via the fastening element, faces a rear side of the housing opposite the front side, so that the connecting cables can be guided through the fastening element recess into a base opening of the base corresponding to the fastening element recess and/or through the fastening element recess and the section of the housing recess adjacent to the third side, in order to be guided out of the housing.
Example 72 is configured according to any one of examples 69 to 71, wherein the housing has a rear side opposite the front side, wherein the first linear insertion guide section and the second linear insertion guide section of the housing are formed on the lower side in a section adjacent to the front side and not in a section adjacent to the rear side.
Example 73 is configured according to any one of examples 69 to 72, wherein the fastening element has a fastening element opening such that the connecting cables can be passed through the fastening element opening into a base opening of the base corresponding to the fastening element opening of the fastening element.
Example 74 is a self-service terminal according to any one of examples 69 to 73, wherein the housing has a rear side opposite the front side, which faces another user of the self-service terminal (e.g., another customer or an attendant), and wherein the self-service terminal further comprises another display and/or control device attached to the housing and directed toward the other user of the self-service terminal. The one or more processors may, for example, be configured to provide a graphical display and/or operating interface on the other display and/or control device (to assist the other user in a self-service process at the self-service terminal and/or to enable an attendant as another user to assist the user in the self-service process at the self-service terminal). Optionally, the self-service terminal can have additional peripherals at the rear, such as another scanner unit (facing the other user).
Example 75 is configured according to example 68, wherein the first side is a front side of the housing and wherein the second side is a rear side of the housing opposite the front side.
Example 76 is configured according to example 75, wherein the third side is a lower side of the housing.
Example 77 is a self-service terminal according to any one of examples 53 to 76, wherein the display and/or control device comprises a touchscreen.
Example 78 is a self-service terminal, comprising: a housing having an upper side, a lower side, and a front side extending between the upper side and the lower side, facing a user of the self-service terminal and defines a front side plane, wherein the housing defines a vertical axis passing through the upper side and lower side, and wherein the housing is provided with a housing opening on the front side; a display and/or control device, a first pivoting device, by means of which the display and/or control device is pivotably attached to the housing and which defines a first pivot axis which extends in a direction which is parallel to or at an angle of less than or equal to 30°, optionally less than or equal to 10°, or further optionally less than or equal to 5°, to the front plane and parallel to or at an angle of less than or equal to 30°, optionally less than or equal to 10°, or further optionally less than or equal to 5°, to the vertical axis, so that the display and/or control device can be pivoted by means of the first pivoting device from a working position in which it is located on the front of the housing into a pivoted-out position in which it is pivoted away towards a lateral side of the housing; a front cover element; a second pivoting device, by means of which the front side cover element is pivotably attached to the housing and which defines a second pivot axis which runs transversely to the first pivot axis and parallel to or at an angle of less than or equal to 30°, optionally less than or equal to 10°, or further optionally less than or equal to 5°, to the front side plane, so that the front side cover element can be pivoted by means of the second pivoting device from a covering position in which it is located on the front side above the housing opening in order to at least partially cover it, into an opening position in which it is pivoted forwards away from the front side.
Example 79 is configured according to example 78, wherein the display and/or control device and the front cover element are configured such that the display and/or control device, in the working position, blocks pivoting of the front cover element from the covering position into the opening position and that the display and/or control device, in the pivoting-out position, does not block pivoting of the front cover element from the covering position into the opening position.
Example 80 is a self-service terminal according to example 78 or 79, wherein the first pivoting device is located closer to the top than to the bottom.
Example 81 is configured according to any one of examples 78 to 80, wherein the second pivoting device is located closer to the bottom than to the top.
Example 82 is a self-service terminal according to any one of examples 78 to 81, further comprising: a scanner unit mechanically connected to the front cover element and extending through an opening of the front cover element to, when the front cover element is in the covering position, enable the user to scan bar codes during the self-service process at the self-service terminal.
Example 83 is a self-service terminal according to example 82, further comprising: an antenna unit mechanically connected to the front cover element, which antenna unit at least partially (e.g. completely) surrounds the scanner unit to enable, when the front cover element is in the covering position, the user to detect and/or invalidate radio frequency, electromagnetic, acoustomagnetic and/or radio frequency identification (RFID) tags (eg, for an Electronic Article Surveillance (EAS) system) during the self-service process at the self-service terminal.
Example 84 is configured according to example 83, wherein the scanner unit and/or the antenna unit does not protrude beyond a front plane (toward the user) defined by a front side of the front cover element.
Example 85 is the self-service terminal of any one of examples 78 to 84, further comprising: one or more cable guides in the housing in a section of the housing opposite the front cover element; a cover flap for at least partially covering the one or more cable guides (and connecting cables routed through the one or more cable guides); and a third pivoting device, by means of which the cover flap is pivotably attached to the housing and which defines a third pivot axis which extends in a direction which is parallel to or at an angle of less than or equal to 30°, optionally less than or equal to 10°, or further optionally less than or equal to 5°, to the front plane and parallel to or at an angle of less than or equal to 30°, optionally less than or equal to 10°, or further optionally less than or equal to 5°, to the vertical axis, so that the cover flap can be pivoted by means of the third pivoting device from a covering position, in which the one or more cable guides are at least partially covered from the direction of the front cover element, into an uncovering position, in which the one or more cable guides are not covered from the direction of the front cover element.
Example 86 is the self-service terminal according to any one of examples 78 to 85, further comprising: a plurality of connection locations within the housing for connecting electrical devices; wherein the housing has, on a third side extending between the front side and a rear side opposite the front side, a housing recess on a section of the third side adjacent to the rear side, through which at least one connecting cable can be passed for connecting a peripheral device arranged outside the housing to at least one connection location of the plurality of connection locations; at least one cable guide (eg, of the one or more cable guides when in conjunction with Example 85) for guiding the at least one connecting cable, wherein the at least one cable guide is arranged in the housing between the plurality of connection locations and the housing recess of the housing and is mechanically connected to the rear side of the housing.
Example 87 is configured according to example 86, wherein the plurality of terminal locations are closer to the upper side than to the lower side.
Example 88 is a self-service terminal according to any one of examples 86 or 87, further comprising a plurality of cable guides adjacent to the at least one cable guide for guiding connecting cables from the connection locations through another housing recess in the housing out of the housing.
Example 89 is configured according to any one of examples 86 to 88, wherein the housing recess is configured such that a connecting element for mechanically connecting the peripheral device to the self-service terminal, optionally to the housing, can be passed through it into the housing, wherein the self-service terminal, optionally the housing, is formed adjacent to the housing recess with a receptacle corresponding to the connecting element, to which the connecting element can be fastened in order to thereby be fastened to the self-service terminal, optionally to the housing; and wherein the connecting element has a passage space which, when the connecting element is fastened to the receptacle, extends from outside the housing through the housing recess into the housing, in order to thereby enable the at least one connecting cable of the peripheral device to be passed from outside the housing via the passage space through the housing recess into the housing.
Example 90 is the self-service terminal according to example 89, further comprising the connecting element.
Example 91 is a self-service terminal according to example 90, further comprising a peripheral device mechanically connected to the self-service terminal, optionally to the housing, by means of the connecting element.
Example 92 is configured according to example 91, wherein the peripheral device comprises one of the following peripheral devices: a printer, a (e.g., bar code) scanner, a camera, a card reader, an operator device, a verification device (e.g., by means of facial recognition, fingerprint recognition, etc.), a scale, etc.
Example 93 is a self-service terminal according to example 91 or 92, wherein the peripheral device has a first device recess, through which the connecting element passes, on a first side of the peripheral device and a second device recess, through which another connecting element for mechanically connecting the peripheral device to another peripheral device can be passed, on a second side of the peripheral device opposite the first side, wherein the peripheral device is formed with a first device receptacle corresponding to the first device recess, to which the connecting element is fastened, and a second device receptacle corresponding to the second device recess, to which the other connecting element can be fastened, such that the other peripheral device can be fastened to the self-service terminal, optionally to the housing, by means of the peripheral device.
Example 94 is configured according to example 91 or 92, wherein the peripheral device has a device recess which extends from a first side to a second side opposite the first side and through which the connecting element extends such that a section of the connecting element adjacent to the second side is not covered by the peripheral device, wherein the section of the connecting element can be fastened to another peripheral device for mechanically connecting the other peripheral device to the self-service terminal, optionally to the housing.
Example 95 is configured according to any one of examples 86 to 94, wherein the housing recess is provided with a panel that is integrally connected to the third side of the housing, optionally by means of one or more predetermined breaking points.
Example 96 is a self-service terminal according to any one of examples 86 to 95, wherein the housing recess further extends into a section adjacent to the third side of a rear side opposite the front side, and wherein the self-service terminal further comprises a cover element which is configured to be detachably fastened to the housing in order to at least partially (e.g. completely) cover the housing recess, wherein the cover element has a first section which at least partially covers the section of the housing recess extending into the rear side, and a second section which at least partially covers the section of the housing recess extending into the third side, wherein the first section and the second section of the cover element are materially connected to one another in one piece by means of one or more predetermined breaking points.
Example 97 is configured according to any one of examples 86 to 96, wherein the housing has another housing recess on a fourth side opposite the third side on a section of the fourth side adjacent to the second side, or wherein the housing recess further extends into the section of the fourth side adjacent to the second side, wherein another connecting element for mechanically connecting another peripheral device to the self-service terminal, optionally to the housing, can be passed through the other housing recess or the housing recess into the housing, wherein the self-service terminal, optionally the housing, is formed adjacent to the other housing recess or the housing recess with another receptacle corresponding to the other connecting element, to which the other connecting element can be fastened in order to thereby be fastened to the self-service terminal, optionally to the housing.
Example 98 is the self-service terminal according to example 97, which further comprises the other connecting element and the other peripheral device, wherein the other peripheral device has a different first device recess, through which the other connecting element passes, on a first side of the other peripheral device and a different second device recess, through which yet another connecting element for mechanically connecting the peripheral device to yet another peripheral device can pass, on a second side of the other peripheral device opposite the first side, wherein the other peripheral device is provided with a further first receptacle corresponding to the other first device recess, to which the other connecting element is fastened, and another second receptacle corresponding to the other second device recess, to which the further connecting element can be fastened, so that the further peripheral device can be fastened by means of the other peripheral device to the self-service terminal, optionally to the housing.
Example 99 is the self-service terminal of example 97, further comprising the other connecting element and the other peripheral device, wherein the other peripheral device has an other device recess extending from a first side to a second side opposite the first side, through which the other connecting element extends such that a section of the other connecting element adjacent to the second side is not covered by the other peripheral device, wherein the section of the other connecting element is attachable to yet another peripheral device for mechanically connecting the yet another peripheral device to the self-service terminal, optionally to the housing.
Example 100 is configured according to any one of examples 78 to 99, wherein the housing is formed on the lower side or a rear side opposite the front side with a first linear insertion guide section and a second linear insertion guide section, which run parallel to one another and thus define a common linear insertion direction and which are arranged at a distance from one another transversely to the linear insertion direction, and wherein the housing is provided with at least one opening for the passage of connecting cables between the two linear insertion guide sections; and wherein the self-service terminal further comprises a fastening element which is configured to be detachably fastened to a base and which has a first and a second correspondence linear insertion guide section which correspond to the first and the second linear insertion guide section of the housing, such that the housing and the fastening element fastened to the base can be assembled along the linear insertion direction via linear insertion, in order to thereby detachably fix the housing to the base via the fastening element.
Example 101 is configured according to example 100, wherein the lower side of the housing is formed with the first linear insertion guide section and the second linear insertion guide section.
Example 102 is configured according to example 101, wherein a front side plane defined by the front side extends at an angle of less than or equal to 80°, optionally less than or equal to 70°, to a lower side plane defined by the lower side and extends obliquely backwards towards the upper side.
Example 103 is configured according to example 101 or 102, wherein the fastening element has a fastening element recess which, when the housing is detachably fixed to the base via the fastening element, faces a rear side of the housing opposite the front side, so that the connecting cables can be guided through the fastening element recess into a base opening of the base corresponding to the fastening element recess and/or through the fastening element recess of the fastening element and the housing recess in order to be guided out of the housing.
Example 104 is a self-service terminal according to any one of examples 101 to 103, wherein the first linear insertion guide section and the second linear insertion guide section of the housing are formed on the lower side in a section adjacent to the front side and not in a section adjacent to the rear side opposite the front side.
Example 105 is configured according to example 100, wherein a rear side of the housing opposite the front side is formed with the first linear insertion guide section and the second linear insertion guide section.
Example 106 is a self-service terminal according to any one of examples 78 to 105, wherein the display and/or control device comprises a touchscreen.

1. A self-service terminal comprising:
a housing having a first side facing a user of the self-service terminal and a second side not facing the user of the self-service terminal, wherein the housing is formed on the second side with a first linear insertion guide section and a second linear insertion guide section, which run parallel to one another and thus define a common linear insertion direction and which are arranged at a distance from one another transversely to the linear insertion direction, and wherein the housing is provided between the two linear insertion guide sections with at least one opening for the passage of connecting cables;
a display and/or operating device attached to the housing and directed towards the user of the self-service terminal;
one or more processors configured to provide a graphical display and/or operating interface on the display and/or operating device to assist the user in a self-service process at the self-service terminal; and
a fastening element which is configured to be detachably fastened to a base and which has first and second corresponding linear insertion guide sections which correspond to the first and second linear insertion guide sections of the housing, such that the housing and the fastening element fastened to the base can be assembled along the linear insertion direction via linear insertion, in order to thereby detachably fix the housing to the base via the fastening element.

2. The self-service terminal according to claim 1 wherein the first side is a front side of the housing and wherein the second side is a bottom side of the housing.

3. The self-service terminal according to claim 2 wherein the housing has an upper side opposite the bottom side, wherein the front side extends between the bottom side and the upper side, wherein the front side extends at an angle of one of less than or equal to 80° and less than or equal to 70° to the bottom side and extends inclined backwards towards the upper side.

4. The self-service terminal according to claim 2 wherein the fastening element has a fastening element recess which, when the housing is releasably secured to the base via the fastening element, faces a rear side of the housing opposite the front side, so that the connecting cables can be guided through the fastening element recess into a base opening of the base corresponding to the fastening element recess and/or through the fastening element recess and a housing recess formed on a section of the rear side adjacent to the bottom side, in order to be guided out of the housing.

5. The self-service terminal according to claim 2 wherein the housing has a rear side opposite the front side, wherein the first linear insertion guide section and the second linear insertion guide section of the housing are formed on the bottom side in a section adjacent to the front side and not in a section adjacent to the rear side.

6. The self-service terminal according to claim 2 wherein the housing has a rear side opposite the front side, which faces another user of the self-service terminal and wherein the self-service terminal further comprises another display and/or operating device attached to the housing and directed towards the other user.

7.-15. (canceled)
